(19) United States
(12) Patent Application Publication
(10) Pub. No.: US 2025/0286596 A1
(43) Pub. Date: Sep. 11, 2025

(54) SYSTEMS AND METHODS FOR CHANNEL STATE INFORMATION REPORT FORMAT AND OMISSION RULE IN COHERENT JOINT TRANSMISSION

(71) Applicant: ZTE CORPORATION, Shenzhen (CN)

(72) Inventors: Bo Gao, Shenzhen (CN); Zhaohua LU, Shenzhen (CN); Minqiang ZOU, Shenzhen (CN); Wenjun YAN, Shenzhen (CN); Guangyu JIANG, Shenzhen (CN)

(73) Assignee: ZTE CORPORATION, Shenzhen (CN)

(21) Appl. No.: 19/219,173

(22) Filed: May 27, 2025

Related U.S. Application Data
(63) Continuation of application No. PCT/CN2023/076555, filed on Feb. 16, 2023.

(51) Int. Cl. H04B 7/06; H04L 5/00

(52) U.S. Cl. CPC H04B 7/0626; H04L 5/0048

(57) ABSTRACT

Presented are systems and methods for channel state information (CSI) report format and omission rule in coherent joint transmission (CJT). A wireless communication device may receive a configuration associated with a set of N_{RS} reference signal (RS) resources from a wireless communication node. N_{RS} can be a positive integer value. The wireless communication device may receive the at least one RS corresponding to the N_{RS} RS resources from the wireless communication node. The wireless communication device may generate a channel state information (CSI) report according to N_{UsedRS} RS resources of the N_{RS} RS resources. The CSI report may comprise a first part and a second part. N_{UsedRS} can be a positive integer value.

### CROSS-REFERENCE TO RELATED APPLICATION

This application claims the benefit of priority under 35 U.S.C. § 120 as a continuation of International Patent Application No. PCT/CN2023/076555, filed on Feb. 16, 2023, the disclosure of which is incorporated herein by reference in its entirety.

### TECHNICAL FIELD

The disclosure relates generally to wireless communications, including but not limited to systems and methods for channel state information (CSI) report format and omission rule in coherent joint transmission (CJT).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., a UE) may receive a configuration (e.g., a CSI report configuration) associated with a set of N_{RS} reference signal (RS) resources from a wireless communication node (e.g., a BS). N_{RS} can be a positive integer value. The wireless communication device may receive the at least one RS corresponding to the N_{RS} RS resources from the wireless communication node. The wireless communication device may generate a channel state information (CSI) report according to N_{UsedRS} RS resources of the N_{RS} RS resources. The CSI report may comprise a first part and a second part. N_{UsedRS} can be a positive integer value. The wireless communication device may send the CSI report to the wireless communication node.

In some embodiments, one RS resource of the N_{RS} RS resources can be associated with a ratio of an energy per resource element (EPRE) of a physical downlink shared channel (PDSCH) to an EPRE of a corresponding RS. The CSI can be determined based on a condition that the PDSCH is transmitted on antenna ports of the N_{UsedRS} RS resources, according to the ratio. Whether N_{UsedRS} is equal to N_{RS}, or is less than or equal to N_{RS}, can be determined according to a report mode parameter in the configuration. The N_{UsedRS} RS resources can be each associated with a same ratio of an EPRE of the PDSCH to an EPRE of the corresponding RS. When the report mode parameter is configured to be a first mode, at least one of: N_{UsedRS} can be equal to N_{RS}; or CSI can be determined according to all of the N_{RS} resources. When the report mode parameter is configured to be a second mode, at least one of: N_{UsedRS} can be less than or equal to N_{RS}; or the wireless communication device can be to indicate (e.g., using a CSI-RS resource indicator via a bitmap corresponding to the CSI-RS resource(s) in the set) the N_{UsedRS} RS resources of the N_{RS} RS resources in the CSI report, and the CSI can be determined according to the N_{UsedRS} RS resources.

In some embodiments, the first part may comprise an indicator of the N_{UsedRS} RS resources selected from of the N_{RS} RS resources. The indicator may comprise a bitmap. A bit size of the bitmap can be determined according to N_{RS}. Bits of the bitmap from most significant bit (MSB) to least significant bit (LSB) can be mapped to the N_{RS} RS resources in order of increasing or decreasing RS resource identifiers (IDs) or RS resource order. A first value (e.g., bit value 1) of a bit of the bitmap may indicate that a corresponding RS resource is selected. A second value (e.g., bit value 0) of the bit may indicate that the corresponding RS resource is not selected. At least one criterion for selecting RS resources, that is configured in the configuration (e.g., CSI report configuration), may comprise at least one of: a maximum number of RS resources in the set is to be selected, a minimum number of RS resources in the set is to be selected, one or more first combinations of RS resources from the set cannot be selected, or one or more second combinations of RS resources from the set can be selected.

In some embodiments, a field of the indicator of the N_{UsedRS} RS resources can be absent or may have zero bit size, when at least one of: a radio resource control (RRC) parameter is configured to indicate that all N_{RS} RS resources are to be used for CSI determination, a RRC parameter is configured to indicate that selection of RS resources for CSI determination is disabled, the N_{RS} RS resources consist of one RS resource for channel measurement, or N_{RS}=1. A field of the indicator of the N_{UsedRS} RS resources can be present, when at least one of: a radio resource control (RRC) parameter is configured to indicate that all or a subset of N_{RS} RS resources are to be used for CSI determination, a RRC parameter is configured to indicate that selection of RS resources for CSI determination is enabled, the N_{RS} RS resources comprise more than one RS resource for channel measurement, or N_{RS} is greater than 1.

In some embodiments, the first part may comprise an indicator of a combination of parameters to be selected from a set of combinations of parameters. The combination of parameters may comprise at least one of: a number of spatial-domain (SD) bases for each of the N_{RS} RS resources, a frequency-domain (FD) basis factor, or a non-zero coefficient factor. A bitwidth of the indicator can be ┌log₂(N_{L})┐, where NL can be a number of combinations of parameters in the set. Capability reporting for the wireless communication device may include at least one of: a maximum number of combinations of parameters, to be configured in the configuration, a maximum number of selected SD bases across the N_{RS} RS resources, or a maximum number of selected SD bases across the N_{UsedRS} RS resources.

In some embodiments, the first part may comprise an indicator of a number of non-zero coefficients (K^{NZ}). The indicator can be determined across the N_{RS} RS resources or the N_{UsedRS} RS resources. The indicator can be provided for each of the N_{RS} RS resources or the N_{UsedRS} RS resources. A bitwidth of the indicator can be determined according to at least one of: a combination of parameters, K₀ or maximum allowed rank. The K₀ can be determined according to a function of M or β, can be determined according to a function of selecting maximum values, or can be determined across the N_{RS} RS resources or the N_{UsedRS} RS resources. The combination of parameters may comprise a selected combination. The combination of parameters may include at least one of: a number of spatial-domain (SD) bases for each of the N_{RS} RS resources, a frequency-domain (FD) basis factor, or a non-zero coefficient factor. When the maximum allowed rank is 1, the bitwidth of the indicator can be ┌log₂(K₀)┐. When the maximum allowed rank is not 1, the bitwidth of the indicator can be ┌log₂(K₀)┐.

In some embodiments, the indicator can be provided for each of the N_{RS} RS resources or the N_{UsedRS} RS resources, wherein at least one of: when the maximum allowed rank is 1, the bitwidth of the indicator for i-th RS resource can be ┌log₂(K₀)┐,

$$min \{ ⌈ {log}_{2} ( {K}_{0} ) ⌉ , ⌈ 2 {L}_{i , J} ⌈ {P}_{v} \times \frac{{N}_{3}}{R} ⌉ ⌉ \} , or \\ min \{ ⌈ {log}_{2} ( {K}_{0} ) ⌉ , ⌈ 2 {L}_{i , J} ⌈ {P}_{m} \times \frac{{N}_{3}}{R} ⌉ ⌉ \} ;$$

or when the maximum allowed rank is not 1, the bitwidth of the indicator for i-th RS resource can be ┌log₂(2K₀)┐, or

$$min \{ ⌈ {log}_{2} ( 2 {K}_{0} ) ⌉ , ⌈ 2 {L}_{i , J} ⌈ {P}_{v} \times \frac{{N}_{3}}{R} ⌉ ⌉ \} .$$

K₀ can be determined according to:

$${K}_{0} = {max}_{j ∈ \{ 1 , … , {N}_{L} \}} ⌈ 2 {L}_{j}^{Total} {M}_{x} β ⌉ ,$$

and wherein

$${M}_{x} = ⌈ {P}_{v} \times \frac{{N}_{3}}{R} ⌉ or {M}_{x} = ⌈ {P}_{m} \times \frac{{N}_{3}}{R} ⌉ ,$$

where Pₘ may denote a FD-basis factor under a given rank of m; or Pᵥ may denote a FD-basis factor for the indicated rank in the CSI report, and Lⱼ^{Total} may denote a total number of spatial-domain (SD) basis across the N_{RS} RS resources for j-th combination of parameters, or

$${L}_{i}^{Total} = {\sum }_{i = 1 , … , {N}_{RS}} 2 {L}_{i , j} .$$

In some embodiments, K₀ can be determined according to:

$${K}_{0} = {max}_{j ∈ \{ 1 , … , {N}_{L} \}} ⌈ ( {\sum }_{i = 1 , … , {N}_{R S}} 2 {L}_{i , j} {M}_{i , j , x} {β}_{i , j} ) ⌉ ,$$

and wherein,

$${M}_{i , j , x} = ⌈ {P}_{i , j , v} \times \frac{{N}_{3}}{R} ⌉ or {M}_{i , j , x} = ⌈ {P}_{i , j , m} \times \frac{{N}_{3}}{R} ⌉ ,$$

where P_{i,j,v} and P_{i,j,m} may denote a FD basis factor of the indicated rank in the CSI report, i-th RS, and j-th combination of parameters, a FD basis factor of the i-th RS and the j-th combination under an indicated rank or a given rank of m, respectively. In some embodiments, the first part may comprise an indicator of an RS resource corresponding to a strongest co-efficient, and wherein a bitwidth of the indicator can be ┌log₂(N_{RS})┐.

In some embodiments, a same value of Pᵥ and a same value of beta (β), can be each associated with each of the RSes. A maximum number of non-zero coefficients summed for one layer can be determined according to:

$$⌈ ( {\sum }_{i ∈ Set of used RS ( s )} 2 {L}_{i , J} ) {M}_{x} β ⌉ , or ⌈ 2 {L}_{J}^{Total} {M}_{x} β ⌉ ;$$

or ┌2L_{J}^{Total}Mₓβ┐; or a maximum number of non-zero coefficients summed across all layers can be determined according to:

$$2 \times ⌈ ( {\sum }_{i ∈ Set of used RS ( s )} 2 {L}_{i , J} ) {M}_{x} β ⌉ , or 2 \times ⌈ 2 {L}_{J}^{Total} {M}_{x} β ⌉ ,$$

or 2×┌2L_{J}^{Total}Mₓβ┐, where ‘Set of used RS(s)’ can be determined according the N_{UsedRS} RS resources, and J may correspond to the combination of parameters used for CSI determination; L_{J}^{Total} may denote a total number of spatial-domain (SD) bases across the N_{RS} RS resources for a J-th combination of parameters used for CSI determination, or

$${L}_{J}^{Tota1} = {\sum }_{i = 1 , … , {N}_{RS}} 2 {L}_{i , J} , {M}_{x} = ⌈ {P}_{v} \times \frac{{N}_{3}}{R} ⌉ or {M}_{x} = ⌈ {P}_{m} \times \frac{{N}_{3}}{R} ⌉ ,$$

where Pᵥ and Pₘ may respectively denote a frequency-domain (FD) basis factor for an indicated rank in the CSI report, and a FD basis factor under a given rank of m.

In some embodiments, Pᵥ and β each may have an individual value associated with each of the N_{RS} RS resources. A maximum number of non-zero coefficients summed for one layer or across all the N_{RS} RS resources, can be determined according to:

$$⌈ ( {\sum }_{i ∈ Set of used RS ( s )} 2 {L}_{i , J} {M}_{i , J , x} {β}_{i , J} ) ⌉ ;$$

or a maximum number of non-zero coefficients summed across all layers or across all the N_{RS} RS resources, can be determined according to the following:

$$2 \times ⌈ ( {\sum }_{i ∈ Set of used RS ( s )} 2 {L}_{i , J} {M}_{i , J , x} {β}_{i , J} ) ⌉ ,$$

where ‘Set of used RS(s)’ can be determined according to the N_{UsedRS} RS resources, and J may correspond to the combination of parameters used for CSI determination;

$${M}_{i , J , x} = ⌈ {P}_{i , J , v} \times \frac{{N}_{3}}{R} ⌉ or {M}_{i , J , x} = ⌈ {P}_{i , J , m} \times \frac{{N}_{3}}{R} ] ,$$

where P_{i,J,v} and P_{i,J,m} respectively may denote a FD basis factor of an indicated rank in the CSI report, i-th RS, and J-th combination of parameters, and a FD basis factor of the i-th RS and the J-th combination under a given rank of m.

In some embodiments, the second part may comprise a number of non-zero coefficients summed across all layers, provided for i-th RS resource. A bitwidth of the indicator, for i-th RS resource, can be determined according to K₀. When a maximum allowed rank is 1, a bitwidth for i-th RS resource can be ┌log₂(K₀)┐. When a maximum allowed rank is not 1, the bitwidth for the i-th RS resource can be ┌log₂(2K₀)┐ A field of ‘the number of non-zero coefficients summed across all layers for i-th RS resources’ can be absent, when N_{UsedRS} or N_{RS} is 1. The i-th RS resource may correspond to any of the N_{UsedRS} RS resources, except for the last one or first one.

In some embodiments, the second part may comprise S number of groups. S can be a positive integer. A first group of the second part may include at least one indicators of selected spatial-domain (SD) bases. There can be a number (N_{UsedRS}) of indicators of selected SD bases for each of the N_{UsedRS} RS resources. A first indicator, from the at least one indicators of selected SD bases, may comprise at least one of an indicator of rotation factor for SD basis and an indicator of SD basis combination. A first group of the second part may include an indicator of a RS resource corresponding to a strongest co-efficient, and a bitwidth of the indicator can be ┌log₂(N_{UsedRS})┐. A first group of the second part may include an indicator of a spatial-domain (SD) basis corresponding to a strongest co-efficient. The first part may include an indicator of a RS resource corresponding to a strongest co-efficient. A bitwidth of the indicator of the RS resource can be ┌log₂(N_{RS})┐. A bitwidth of the indicator of the SD basis can be ┌log₂(2Lᵢ)┐, ┌log₂(K^{NZ})┐, min{┌log₂(K^{NZ})┐, ┌log₂(2Lᵢ)┐} or ┌log₂(min{K^{NZ},2Lᵢ})┐. A bitwidth of the indicator of the SD basis can be ┌log₂(2Lᵢ)┐ regardless of rank. For rank-1, the bitwidth of the indicator of the SD basis can be ┌log₂(K^{NZ})┐, min{┌log₂(K^{NZ})┐, ┌log₂(2Lᵢ)┐} or ┌log₂(min{K^{NZ},2Lᵢ})┐. For other than rank-1, the bitwidth of the indicator of the SD basis can be ┌log₂(2Lᵢ)┐.

In some embodiments, the first group of the second part or the second part may include an indicator of a RS resource corresponding to a strongest co-efficient, and wherein at least one of: a bitwidth of the indicator of the RS resource can be ┌log₂(N_{UsedRS})┐; a bitwidth of the indicator of the SD basis can be

$${max}_{i ∈ Set of used RS ( s )} \{ ⌈ {log}_{2} ( 2 {L}_{i} ) ⌉ \} or ⌈ {log}_{2} ( {K}^{N Z} ) ⌉ - bit ;$$

or ┌log₂(K^{NZ})┐-bit; for rank-1, the bitwidth of the indicator of the SD basis can be ┌log₂(K^{NZ})┐; or for other than rank-1, the bitwidth of the indicator of the SD basis can be

$${max}_{i ∈ Set of used RS ( s )} \{ ⌈ {log}_{2} ( 2 {L}_{i} ) ⌉ \} .$$

The indicator of the spatial-domain (SD) basis corresponding to the strongest co-efficient can be indicated across the N_{UsedRS} RS resources, and wherein the bitwidth of the indicator can be

$$⌈ {log}_{2} ( {\sum }_{i ∈ Set of used RS ( s )} 2 {L}_{i} ) ⌉ or ⌈ {log}_{2} ( {K}^{N Z} ) ⌉ .$$

or ┌log₂(K^{NZ})┐.

In some embodiments, for rank-1, the bitwidth of the indicator can be ┌log₂(K^{NZ})┐, or for other than rank-1,

$$⌈ {log}_{2} ( {\sum }_{i ∈ Set of used RS ( s )} 2 {L}_{i} ) ⌉ .$$

In some embodiments, the CSI may comprise an indicator of one or more of the N_{UsedRS} RS resources for a RS group with an index of t, where t can be integer. The first group of the second part of the CSI may comprise the indicator of one or more of N_{UsedRS} RS resources. A number of the one or more of the N_{UsedRS} RS resources can be determined according to a function of T or N_{UsedRS}/T, or can be ┌N_{UsedRS}/T┐ or ┌N_{UsedRS}/T┐. T can be a total number of groups and can be a positive integer. The one or more of the N_{UsedRS} RS resources form a RS group with index of t=0, and rest of the N_{UsedRS} RS resources may form a RS group with index of t=1. The indicator may correspond to a bitmap, where the bitwidth can be a number of used RS resources. The indicator may correspond to a combination number with a bitwidth of

$$⌈ {log}_{2} ( \begin{matrix}{N}_{UsedRS} \\ {N}_{t}\end{matrix} ) ⌉$$

bit, where the bitwidth can be a number of used RS resources, and Nₜ may denote a number of RSs for the RS group with index of t. The combination number can be a single parameter (e.g., a value of 31) to point more than one parameter (e.g., a value of 6 and 1). For instance, the first value may equal to floor (X/5), and the second value may equal to X %5.

In some embodiments, a RS group with an index of t=0 may comprise a RS resource corresponding to a strongest co-efficient. A RS group with an index of t=1 may comprise rest of used RSs except for the RS resource corresponding to a strongest co-efficient. Each RS group may have a respective priority level in terms of CSI omission. A priority value for a non-zero coefficient corresponding to the RS group with index of t in terms of CSI omission can be determined according to t. The number of RS groups can be 2. A second group of the second part may include an indicator of one or more selected frequency-domain (FD) bases, wherein at least one of: the indicator may comprise a respective indicator provided for each of the N_{UsedRS} RS resources; for rank-v transmission, if N₃<=a threshold, the bitwidth can be

$$⌈ {log}_{2} ( \begin{matrix}{N}_{3} - 1 \\ {M}_{v} - 1\end{matrix} ) ⌉ or ⌈ {log}_{2} ( \begin{matrix}{N}_{3} \\ {M}_{v}\end{matrix} ) ⌉ - bit ;$$

for other than rank-v transmission, if N₃>the threshold, the bitwidth can be

$$⌈ {log}_{2} ( \begin{matrix}2 {M}_{3} - 1 \\ {M}_{v} - 1\end{matrix} ) ⌉ or ⌈ {log}_{2} ( \begin{matrix}2 {M}_{3} \\ {M}_{V}\end{matrix} ) ⌉ - bit ;$$

when a RS resource used for CSI determination is indicated by another indicator of RS resource corresponding to a strongest co-efficient among co-efficients, a bitwidth of the indicator can be

$$⌈ {log}_{2} ( \begin{matrix}2 {M}_{3} - 1 \\ {M}_{v} - 1\end{matrix} ) ⌉ or ⌈ {log}_{2} ( \begin{matrix}{N}_{3} - 1 \\ {M}_{v} - 1\end{matrix} ) ⌉ - bit ;$$

where a reference FD basis can be assumed as 0; or when a RS used for CSI determination is indicated by another indicator, the bitwidth of the indicator can be

$$⌈ {log}_{2} ( \begin{matrix}{N}_{3} \\ {M}_{v}\end{matrix} ) ⌉ - bit or ⌈ {log}_{2} ( \begin{matrix}2 {M}_{3} \\ {M}_{v}\end{matrix} ) ⌉ - bit .$$

In some embodiments, a second group of the second part may include an indicator of window of selected frequency-domain (FD) bases, wherein at least one of: the indicator of the window of selected FD bases may comprise a respective indicator provided for each of the N_{UsedRS} RS resources; or the indicator can be applied to all layers, or may comprise a respective indicator provided for each of the layers, or provided for a specific layer. A second group of the second part may include at least one indicator of offset of selected frequency-domain (FD) bases, wherein at least one of: the at least one indicator may provide an offset of reference FD bases between one of the N_{UsedRS} RS resources and a reference RS resource; the at least one indicator may provide an offset of FD bases between one of the N_{UsedRS} RS resources and a reference RS resource; the respective offset can be an offset of window of the selected FD bases between a respective RS resource and the reference RS resource; the at least one indicator can be provided for one of the N_{UsedRS} RS resources except for the reference RS resource, wherein a number of the at least one indicator can be (N_{UsedRS}−1); the reference RS resource may correspond to a strongest co-efficient, and can be determined according to an indicator of spatial-domain (SD) basis corresponding to the strongest co-efficient or an indicator of RS resource corresponding to the strongest co-efficient; bitwidth of the at least one indicator can be ┌log₂(┌N₃×b┐)┐-bit, where b can be a defined integer value or provided in the configuration; or a candidate value of the at least one indicator of offset between reference FD bases can be from a range of 0 to N₃−1/b or from a range of 0 to N₃b−1. A second group of the second part may include reference amplitudes for at least one specific layer.

In some embodiments, a second group of the second part may include at least one first group of amplitude values for at least one non-zero coefficient. A first group of amplitude values for a non-zero coefficient can be determined according to a priority function.

In some embodiments, a second group of the second part may include at least one first group of phase values for at least one non-zero coefficient. A first group of phase values for a non-zero coefficient can be determined according to a priority function. A second group of the second part may include at least one first group of indicators for at least one non-zero coefficient. A first group of indicators for a non-zero coefficient can be determined according to a priority function. The first group may comprise at least one amplitude value corresponding to a RS resource indicated by at least one of: an indicator of one or more RSs from the N_{UsedRS} RS resources; or an RS corresponding to a strongest coefficient.

In some embodiments, a third group of the second part may include at least one second group of amplitude values for at least one non-zero coefficient. A second group of amplitude values for a non-zero coefficient can be determined according to a priority function. A second group of the second part may include at least one second group of phase values for at least one non-zero coefficient. A second group of phase values for a non-zero coefficient can be determined according to a priority function.

In some embodiments, a second group of the second part may include at least one second group of indicators for at least one non-zero coefficient. A second group of indicators for a non-zero coefficient can be determined according to a priority function. For the S groups of the second part, there can be a corresponding t-th group of amplitude values for non-zero coefficients, of phase values for the non-zero coefficients, or of indicators for the non-zero coefficients, for each respective one of last S-1 or last S-2 groups of the second part, in order of the S groups. When the CSI report cannot be fully carried in physical uplink shared channel (PUSCH), the wireless communication device may omit a portion of the second part.

In some embodiments, a group of the second part may have a lower priority for omission (e.g., higher likelihood for being omitted) relative to another group that is earlier in order or has a lower group index in the second part. A higher priority may mean/indicate higher priority for transmission/keeping in the CSI report (rather than being omitted). The wireless communication device may prioritize bits for amplitude values for non-zero coefficients, for phase values for the non-zero coefficients, or for indicators for non-zero coefficients, according to a priority function, to be carried in the PUSCH. A non-zero coefficient having a highest priority may have a lowest associated value of the priority function. The priority function can be a function of: index of layer (l), index of spatial-domain (SD) basis (i), index of frequency-domain (FD) basis (f), or index of RS group of one or more RS resources (t). For determining a value of the priority function, the index of RS group can be more significant over at least one of: the index of layer, the index of SD basis, or the index of FD basis.

In some embodiments, when a number of layers is v, a number of SD basis is L, and a number of FD basis is Mv, the priority function may have a value determined according to one of: 2*L*v*Mv*t, or 2*L*v*t, or v*t. When a number of layers is v, a number of SD basis is L, and a number of FD basis is Mv, the priority function can be:

$$Pri ( l , i , f , t ) = 2 L \cdot v \cdot {M}_{v} \cdot t + 2 L \cdot v \cdot π ( f ) + v \cdot i + l .$$

In some embodiments, a wireless communication node (e.g., a BS) may send a configuration (e.g., a CSI report configuration) associated with a set of N_{RS} reference signal (RS) resources to a wireless communication device (e.g., a UE). N_{RS} can be a positive integer value. The wireless communication node may receive the at least one RS corresponding to the N_{RS} RS resources from the wireless communication device. The wireless communication device may generate according to N_{UsedRS} RS resources of the N_{RS} RS resources, a channel state information (CSI) report, the CSI report comprising a first part and a second part. N_{UsedRS} can be a positive integer value.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of multi-transmission and reception points (TRPs) based transmission for serving a single user equipment, in accordance with some embodiments of the present disclosure;

FIG. 4 illustrates an example joint precoding across different transmission and reception points (TRPs) for coherent joint transmission, in accordance with some embodiments of the present disclosure;

FIG. 5 illustrates an example reference signal configuration for a coherent joint transmission channel state information report, in accordance with some embodiments of the present disclosure;

FIG. 6 illustrates an example reference signal configuration for a coherent joint transmission channel state information report, in accordance with some embodiments of the present disclosure; and

FIG. 7 illustrates a flow diagram for generating a channel state information (CSI) report, in accordance with an embodiment of the present disclosure.

### DETAILED DESCRIPTION

### 1. Mobile Communication Technology and Environment

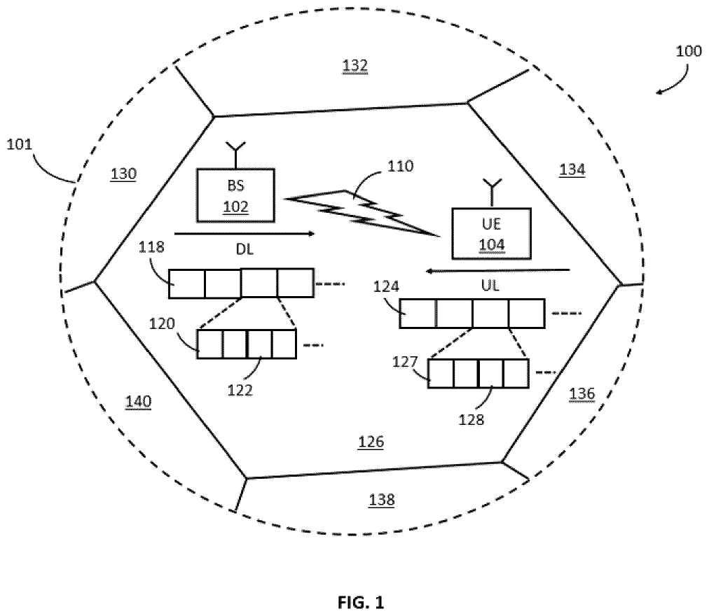

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

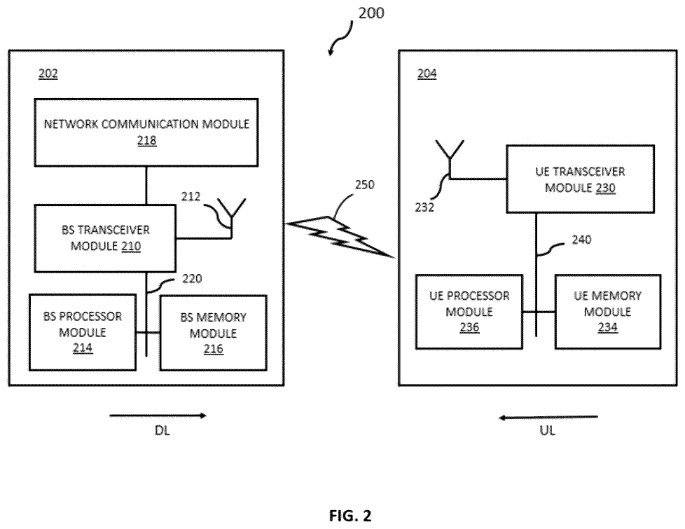

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Channel State Information (CSI) Report Format and Omission Rule in Coherent Joint Transmission (CJT)

In 5G new radio (NR), for sake of implementation deployment, most of efforts are paid on single transmission and reception points (TRP) transmission and multi-TRPs transmission with non-coherent joint transmission (NC-JT). A multi-TRPs transmission can obtain some performance gains over a single TRP transmission, such as for a cell-edge UE, with appropriate increase of implementation complexity. However, the benefit of having NC-JT may be limited for average throughput improvement, especially considering advanced transmission scheme of coherent joint transmission (CJT). A coherent joint transmission (CJT) can obtain distinct/optimal performance for multi-user multiple input multiple output (MU-MIMO) in a multi-TRPs operation.

Therefore, in order to support CJT (such as for FDD, e.g., FDD re-farming in sub-GHz bands), this emerging technique of CSI report format and corresponding CSI omission rules in CJT can be considered. For example, the following issues can be investigated.

(1) A channel state information (CSI) codebook and corresponding parameters (e.g., a ratio of an energy per resource element (EPRE) of a physical downlink sharing channel (PDSCH) to a channel state information reference signal (CSI-RS)) for reestablishing precoding information in CJT-CSI can be studied based on a multi-TRP-CJT architecture. Different from a CSI codebook for single TRP (sTRP) (e.g., eTypeII CSI codebook), the CJT-CSI codebook may provide a selection of TRPs (e.g., selected CSI-RS resources (each of the selected CSI-RS resources may correspond to a TRP)), and may provide correlation information of a CSI precoding across different TRPs according to power offset(s) between a PDSCH and selected CSI-RS resource(s).

(2) In order to balance CSI report overhead (e.g., 200˜2000 bits) and MU-MIMO performance, dividing CJT-CSI report format into different categories may be considered. First information for CJT-CSI codebook may have a highest priority and a fixed bitwidth determined according to CSI report configuration from a gNB side. The first information for CJT-CSI codebook can clearly indicate a total number of bits for the rest of CSI parts. The other CSI parts (e.g., CSI part-2 group 0˜2) can have different levels of priorities. Based on available physical uplink sharing channel (PUSCH) resource(s), each of groups in the CSI part-2 can be carried by order. Once being beyond payload size of current PUSCH resource(s), the corresponding lower-priority CSI parts can be omitted accordingly.

(3) Due to having multi TRP (mTRP) operation, CSI omission rules (e.g., how to prioritize different bits in CSI part-2 by grouping different bits into different groups with different priorities) may be considered. The strongest TRP may mainly contribute to throughput performance of CJT CSI compared with other TRPs.

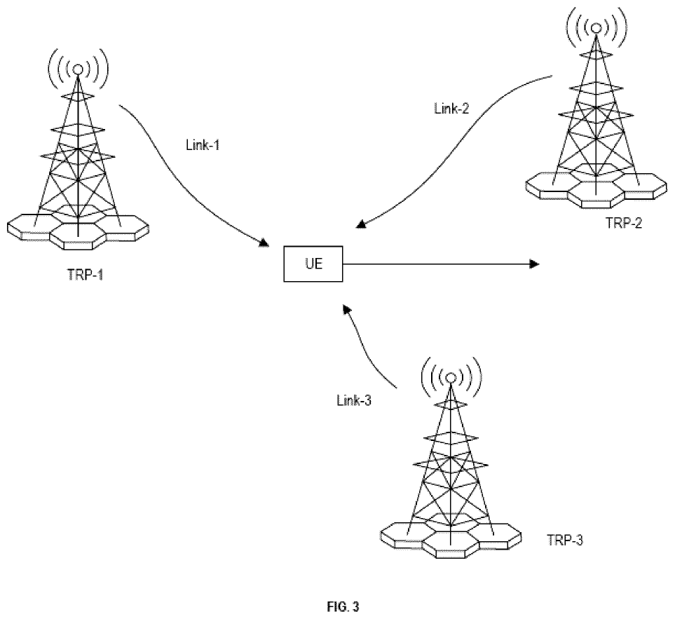

As the expense of wide or ultra-wide spectrum resources and massive or large-massive MIMO in a single TRP site, multi-TRP operation can be considered as an emerging technique for balancing the deployment cost and throughput/robustness. As shown in FIG. 3, an example for multi-TRPs operation is provided accordingly. In such case, especially for frequency division duplex (FDD) or a cell-edge UE in time division duplex (TDD), CSI information (e.g., a precoding matrix indicator (PMI), a rank indicator (RI), or a channel quality indicator (CQI)) for determining DL precoding can be reported from a UE to a gNB. For a single layer (or a DMRS port), the precoding can be provided across DL Tx antennas from multi-TRPs accordingly.

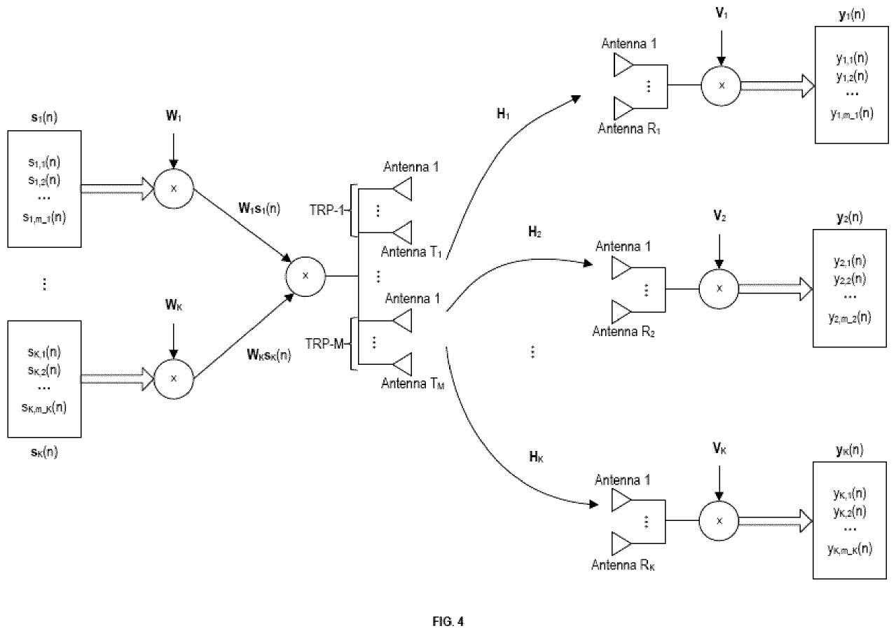

FIG. 4 shows an example transmission scheme for multi-user multiple input multiple output (MU-MIMO) in a coherent joint transmission (CJT). In order to achieve an ideal precoding, regardless of zero-forcing or signal to leakage and noise ratio (SLNR) mechanisms, a complete channel related information H may be considered. Besides for right eigenvector V in H, left eigenvector U and eigenvalue vector(s) may be used for reconstructing the channels accordingly.

The SLNR can be defined as:

$${SLNR}_{i} = \frac{T r ( {W}_{i}^{H} {H}_{i}^{H} {H}_{i} {W}_{i} )}{Tr ( {w}_{i}^{H} ( {M}_{i} {σ}_{i}^{2} + {\tilde{H}}_{i}^{H} {\tilde{H}}_{i} ) {W}_{i} )} ,$$

where \tilde{H}ᵢ=[H₁ . . . Hᵢ₋₁ Hᵢ₊₁ . . . H_{K}].

For S-layer transmission for i-th UE, the precoding information can be given by: Wᵢ∝max. S eigenvectors ((Mᵢσᵢ²+\tilde{H}ᵢ^{H}\tilde{H}ᵢ)⁻¹Hᵢ^{H}Hᵢ).

A “RS” can be a CSI-RS, a synchronization signal block (SSB), or a sounding reference signal (SRS). A “time unit” can be sub-symbol, symbol, slot, sub-frame, frame, or transmission occasion. A “CSI” may comprise at least one of “precoding information”, “PMI”, “CQI”, and/or “RI”. A ‘precoding parameter’ can be equivalent to a parameter of CSI codebook, a parameter related to precoding matrix indicator (PMI), or a parameter related to PMI codebook. A “precoding information” can be equivalent to a precoding matrix indicator (PMI) or a transmission precoding matrix indicator (TPMI). A “TRP” can be equivalent to a RS port, a RS port group, a RS resource, or a RS resource set.

### Implementation Example 1: Reference Signal Configuration and Channel State Information (CSI) Report for Coherent Joint Transmission (CJT)

For channel state information (CSI) codebook/reporting for a coherent joint transmission (CJT), a mechanism of distinguishing different TRPs may be provided by using different CSI-RS resource(s) (e.g., CSI-RS for channel measurement). There can be a number of CSI-RS resources (NCSI-RS) in a CSI-RS resource set for channel measurement. In such case, a CSI-RS resource may correspond to a TRP/TRP-group. On the other hand, for interference measurement, non-zero-power (NZP) interference measurement resource (IMR) (NZP-IMR) (e.g., a CSI-RS for interference measurement or zero-power IMR (ZP-IMR)) may be configured. CSI (e.g., PMI, RI or CQI) can be derived according to all or a subset of CSI-RS resources in the set according to a report mode parameter in a CSI report configuration.

After receiving CSI report configuration associated with reference signals (RSs) (e.g., CSI-RS for channel measurement, ZP-IMR and/or NZP-IMR), the UE may receive reference signals according to the CI report configuration. The UE may determine a CSI report. The CSI report may comprise at least one of: CSI part-1 or CSI part-2. The UE may send the CSI report to a gNB side.

In some embodiments, one of RS(s) in a set can be associated with a ratio of an energy per resource element (EPRE) of a PDSCH to a reference signal (RS) (e.g., powerControlOffset). For instance, a ratio of an EPRE of a PDSCH to a RS can be a ratio of a PDSCH EPRE to a CSI-RS EPRE (e.g., NZP-CSI-RS). In some embodiments, for CSI determination, the UE may assume that a PDSCH (e.g., all layers) is transmitted on the antenna ports of one or more RS resources from the RS(s) according to the ratio of the EPRE.

In some embodiments, one or more RS resource(s) used for CSI determination can be a subset or all of RS resources in a set according to a report mode parameter in a CSI report configuration. If a report mode parameter is configured for being based on all of CSI-RS resource(s) in a set, CSI (e.g., PMI, RI or CQI) may be determined according to all of CSI-RS resource(s). Otherwise, if a report mode parameter is configured for being based on a subset of CSI-RS resource(s) in a set, the UE may indicate the subset of CSI-RS resources (e.g., using a CSI-RS resource indicator via a bitmap corresponding to the CSI-RS resource(s) in the set). The CSI (e.g., PMI, RI or CQI) can be determined according to the subset of CSI-RS resource(s).

In some embodiments, all of RS(s) in a set, or the one or more RS resource(s) used for CSI determination may be associated with a same power ratio of a PDSCH to a RS (e.g. a ratio of a PDSCH EPRE to a NZP CSI-RS EPRE).

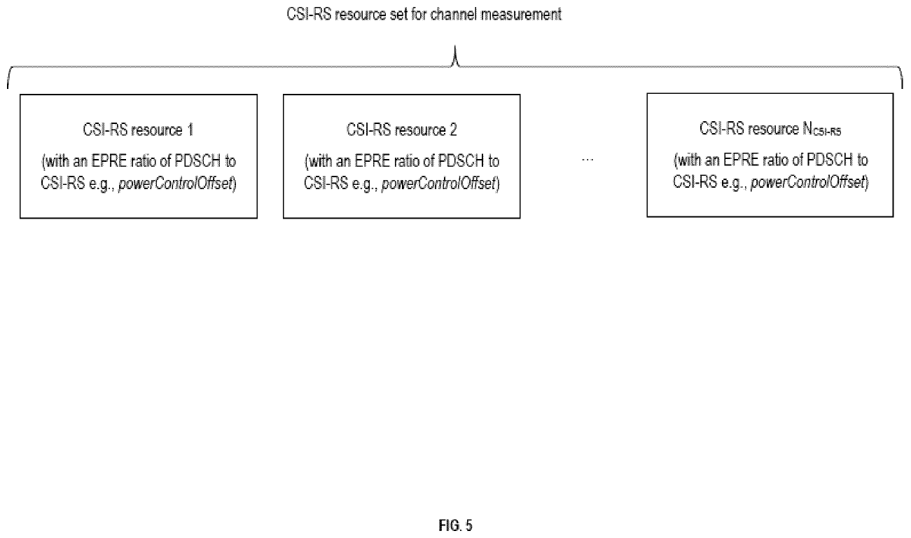

FIG. 5 illustrates an example reference signal configuration for a coherent joint transmission (CJT) channel state information report (e.g., CSI-RS resource set for channel measurement), in accordance with some embodiments of the present disclosure. A respective ratio of an EPRE of a PDSCH to a CSI-RS can be provided for each of CSI-RS resources in the set. In order to facilitate the CSI determination in CJT and reduce the complexity of the UE side CSI derivation, all of CSI-RS resource(s) in the set, or all of CSI-RS resources used for CSI determination (e.g., the subset or all of RS resources in the set) may be associated with a same power ratio.

In CJT CSI, following CSI codebooks for constructing precoding matrix (e.g., PMI) can be provided.

Case-1: Per-TRP SD/FD basis selection. The per-TRP SD/FD basis selection may allow independent FD basis selection across N TRPs/TRP groups. N_{UsedRS} may denote a number of RS resources selected/used for a CSI determination (e.g., the number of CSI-RS resources from the CSI-RS resource set):

$$[ \begin{matrix}{W}_{1 , 1} {W}_{2 , 1} {W}_{f , 1}^{H} \\ ⋮ \\ {W}_{1 , {N}_{UsedRS}} {W}_{2 , {N}_{UsedRS}} {W}_{f , {N}_{UsedRS}}^{H}\end{matrix} ] .$$

Case-2: Per-TRP SD basis selection and joint/common (across N TRPs) FD basis selection.

$$[ \begin{matrix}{W}_{1 , 1} {W}_{2 , 1} {W}_{f}^{H} \\ ⋮ \\ {W}_{1 , {N}_{UsedRS}} {W}_{2 , {N}_{UsedRS}} {W}_{f}^{H}\end{matrix} ] .$$

After that, in order to balance CSI report overhead (e.g., 200˜2000 bits) and codebook performance, dividing CJT-CSI report format into different categories need to be considered. The following parameter can be captured in the CJT-CSI report format to be reported to gNB from the UE (i.e., initial categories for CSI part-1 and CSI part-2).

CSI Part-1: The CSI Part-1 may carry the first/most essential precoding parameters in CJT-CSI (including at least channel quality information (CQI) (wideband, or subband), a rank indicator (RI), and a portion of precoding parameters (e.g., a number of non-zero coefficients summed across all layers, e.g., for W2). The CSI Part-1 may have a highest priority and a fixed bitwidth determined according to a CSI report configuration from the gNB side. The total number of bits (for each of groups in the CSI Part-2) can be calculated according to the portion of precoding parameters in the CSI Part-1.

CSI Part-2: The CSI Part-2 may comprise a number of CSI part-2 groups (e.g., CSI part-2 group 0˜2). The first group may include a plurality of wideband (WB) parameters related to the CSI codebook. One of the rest groups may include a plurality of subband (SB) parameters related to the CSI codebook. In the CSI part-2, a number of groups in the CSI part-2 (e.g., CSI part-2 group 0˜2) can have different levels of priorities. Based on a payload size of available PUSCH resource(s) for the CSI report, each of groups in the CSI part-2 can be carried by order. Once being beyond maximum payload size of current PUSCH resource, the corresponding lower-priority CSI parts can be omitted.

For instance, Table 1 illustrates an example CSI report format in a coherent joint transmission (CJT). The CSI part(s) may include at least one of: a CSI-Part 1 or S groups in CSI Part-2.

TABLE 1

| | |
|---|---|
| CSI Part-1 | WB CQI, SB CQI, RI, the portion of precoding parameters (e.g., the |
| | portion of PMI, such as the number of non-zero coefficients summed |
| | across all layers) |
| CSI Part-2 | CSI part-2 group-0 |
| | CSI part-2 group-1 |
| | . . . |
| | CSI part-2 group-‘S-1’ |

In the following implementation examples, the above CSI parts and corresponding CSI omission rule(s) are discussed.

In Implementation Example 2, details about report format for CSI part-1 can be found. In Implementation Example 3, details about report format for CSI part-2 can be found. In Implementation Example 4, a CSI omission rule regarding one or more CSI-RS resources used for deriving CSI can be found.

### Implementation Example 2: Report Format for CSI Part-1

In this implementation example, details about report format for CSI part-1 are elaborated. A CSI part-1 can comprise at least one of the following: an indicator of one or more RS resources selected from a set of RS resources, an indicator of a combination of parameters to be selected or used for CSI determination, an indicator of a number of non-zero coefficients (K^{NZ}), or an indicator of an RS resource corresponding to a strongest co-efficient among co-efficients.

The CSI part-1 can comprise an indicator of one or more RS resources selected from a set of RS resources. The indicator of one or more RS resources selected from a set of RS resources can be an indicator of selected CSI-RS resource(s). With this indicator, N_{UsedRS} RS resource(s) (e.g., CSI-RS resources) can be selected from the N_{RS} RS resources (e.g., CSI-RS resources) in a set. The selected CSI-RS resource(s) can be used for deriving CSI (e.g., CSI determination). In some embodiments, the indicator of selected RS resource(s) may comprise a bitmap. A bit size of the bitmap can be determined according to the number of RS resource(s) in the set (e.g., N_{RS} (e.g., for channel measurement)).

In some embodiments, there can be a mapping between a bit of bitmap from most significant bit (MSB) to least significant bit (LSB), and at least one of RS resources by order. In other words, the bits of the bitmap from MSB to LSB can mapped to at least one of the following by order: RS resources with lowest ID to highest ID, RS resources with highest ID to lowest ID, a first RS resource to a last RS resource, or a last RS resource to a first RS resource. “1” in the bit of bitmap may indicate/refer to that the RS associated with the bit is selected. Otherwise, “0” in the bit of bitmap may indicate/refer to that the RS associated with the bit is NOT selected.

In some embodiments, the field of ‘indicator of selected RS resource(s)’ can be absent, or the bit size of the field can be zero, if at least one of the following conditions is satisfied.

Condition #1: RRC parameter is configured that all RS(s) for channel measurement (e.g., in the set) can be used for deriving CSI.

Condition #2: RRC parameter is configured that the RS selection for CSI determination is disabled.

Condition #3: There is only one RS resource for channel measurement in the set.

In some embodiments, at least one of following can be configured as criterion for selecting RS resources (e.g., CSI-RS resources for channel measurement) in the CSI report:

Criteria-1: The maximum number of RS resource(s) in the set that can be selected.

Criteria-2: The minimum number of RS resource(s) in the set that can be selected.

Criteria-3: One or more combinations of RS resource(s) in the set that can NOT be selected in the CSI report. For instance, there can be 4 TRPs (e.g., 4 CSI-RS resource(s) in a set), such as TRP-1/2/3/4. TRP-1 and TRP-2 can be used together for CJT-CSI as a TRP-group-1. TRP-3 and TRP-4 can be used together for CJT-CSI as TRP-group-2, but TRP(s) from different group may not be used for CJT-CSI. From a signaling perspective, it can be configured that {TRP-1, TRP-3}, {TRP-1, TRP-4}, {TRP-2, TRP-3}, {TRP-2, TRP-4} may not be simultaneously indicated in the CSI report.

Criteria-4: One or more combinations of RS resource(s) in the set that can be selected in the CSI report. For instance, there can be 4 TRPs, such as TRP-1/2/3/4. TRP-1 and TRP-2 can be used together for CJT-CSI as a TRP-group-1. TRP-3 and TRP-4 can be used together for CJT-CSI as TRP-group-2. TRP(s) from different group may not be used for CJT-CSI. From a signaling perspective, it can be configured that {TRP-1, TRP-2} and {TRP-3, TRP-4} can be simultaneously indicated in the CSI report.

The CSI part-1 can comprise an indicator of a combination of parameters to be selected or used for CSI determination. The indicator of a combination of parameters to be selected or used for CSI determination can be from a plurality of candidate combinations. In some embodiment, the indicator of parameter combination can indicate the parameter combination associated with the CSI. For instance, the indicator can be called as an indicator of parameter combination for deriving CSI or precoding information. The parameter combination may comprise at least one of the number of SD-bases for each RS resources (e.g., {L₁, L₂, . . . , L_{N_RS}}), a FD-basis factor (e.g., Pᵥ or Pₘ), or a non-zero coefficient factor (e.g., Beta). In other words, for number of SD bases (L), L_{i,j} may denote the number of selected SD bases for i-th CSI-RS/TRP in j-th parameter combination. In such case, Pᵥ may denote a frequency-domain (FD)-basis factor (e.g., determining the number of FD bases) to be indicated in the CSI report, and Beta may denote a factor for determining the number of non-zero coefficients.

In a RRC level, a plurality of parameter combinations (e.g., N_{L}) can be configured. The UE side may indicate one of parameter combinations. The bitwidth for this indicator can be ┌log₂(N_{L})┐.

In some embodiments, in order to support different types of UE implementation, at least of following can be reported as in a UE capability signaling: a maximum number of parameter combinations to be configured in the CSI report configuration, a maximum number of selected SD bases across CSI-RS resource(s) (e.g., in a parameter combination), or a maximum number of selected spatial domain (SD) bases across selected CSI-RS resource(s) (e.g., in a parameter combination). The maximum number of selected SD bases across CSI-RS resource(s) can be a maximum number of summing {L₁, L₂, . . . , L_{N_RS}} in a parameter combination.

The CSI part-1 may comprise an indicator of a number of non-zero coefficients. The indicator of a number of non-zero coefficients can be K^{NZ}. The number of non-zero coefficients can be determined across all layers. The indicator of the number of non-zero coefficients may comprise/refer to a total number of non-zero coefficients summed across all layers.

In some embodiments, the indicator can be determined across all selected RS resource(s) (e.g., all selected CSI-RS resource(s)) associated with the CSI report (e.g., N_{UsedRS} CSI-RS).

In some embodiments, a bitwidth of K^{NZ} can be determined according to a parameter combination, e.g., {L₁, L₂, . . . , L_{N_RS}}, Pᵥ, and/or Beta. In some embodiments, the parameter combination may comprise a selected parameter combination.

In some embodiments, a bitwidth of the indicator of the total number of non-zero coefficients (K^{NZ}) can be determined according to at least one of K0 and max allowed rank. When the max allowed rank is 1, the bitwidth can be ┌log₂(K₀)┐; otherwise, the bitwidth can be ┌log₂(2K₀)┐. Pᵥ and beta (β) can be TRP-common (e.g., same value associated with each of CSI-RS resources). The K0 can be determined according to the following formula:

$${K}_{0} = {max}_{j ∈ \{ 1 , … , {N}_{L} \}} ⌈ 2 {L}_{J}^{Total} {M}_{x} β ⌉ .$$

Furthermore,

$${M}_{x} = ⌈ {P}_{v} \times \frac{{N}_{3}}{R} ⌉ or {M}_{x} = ⌈ {P}_{m} \times \frac{{N}_{3}}{R} ⌉ .$$

Pᵥ and Pₘ may denote a FD-basis factor for the indicated rank in the CSI report and a FD-basis factor under a given rank of m (e.g., rank can be assumed as m=1).

In such case, Lⱼ^{Total} may denote a total number of spatial domain (SD)-basis across CSI-RS resources in a set. That is

$${L}_{j}^{Total} = {\sum }_{i = 1 , … , {N}_{R S}} 2 {L}_{i , j} .$$

For guaranteeing a consistency of bitwidth, the above sum can be from 1 to N_{RS}, rather than N_{UsedRS}.

In some embodiments, Pᵥ and beta (β) can be TRP-specific (e.g., individual value associated with each of CSI-RS). K0 can be determined according to the following formula:

$${K}_{0} = {max}_{j ∈ \{ 1 , … , {N}_{L} \}} ⌈ ( {\sum }_{i = 1 , … , {N}_{RS}} 2 {L}_{i , j} {M}_{i , j , x} {β}_{i , j} ) ⌉ .$$

Furthermore,

$${M}_{i , j , x} = ⌈ {P}_{i , j , v} \times \frac{{N}_{3}}{R} ⌉ or {M}_{i , j , x} = ⌈ {P}_{i , j , m} \times \frac{{N}_{3}}{R} ⌉ .$$

P_{i,j,v} and P_{i,j,m} may denote a FD-basis factor of the indicated rank in the CSI report, i-th RS, and j-th parameter combination, a FD-basis factor of i-th RS and j-th parameter combination under a given rank of m (e.g., rank can be assumed as m=1). For guaranteeing a consistency of bitwidth, the above sum for L_{i,j} can be from 1 to N_{RS}, rather than N_{UsedRS}.

In some embodiments, the indicator can be provided per RS(s), e.g., for each of N_{RS} CSI-RS resources. Furthermore, bitwidth of K^{NZ} can be determined according to a parameter combination, e.g., {L₁, L₂, . . . , L_{N_RS}}, Pᵥ, Pₘ, and Beta. Furthermore, the parameter combination may comprise a selected parameter combination. A bitwidth of K^{NZ} can be determined according to K0 and a max allowed rank. When the max allowed rank is 1, a bitwidth for i-th RS resource can be ┌log₂(K₀)┐,

$$min \{ ⌈ {log}_{2} ( {K}_{0} ) ⌉ , ⌈ 2 {L}_{i , J} ⌈ {P}_{v} \times \frac{{N}_{3}}{R} ⌉ ⌉ \} , or \\ min \{ ⌈ {log}_{2} ( {K}_{0} ) ⌉ , ⌈ 2 {L}_{i , J} ⌈ {P}_{m} \times \frac{{N}_{3}}{R} ⌉ ⌉ \} .$$

In certain embodiments, a bitwidth for i-th RS resource can be ┌log₂(2K₀)┐, or

$$min \{ ⌈ {log}_{2} ( 2 {K}_{0} ) ⌉ , ⌈ 2 {L}_{i , J} ⌈ {P}_{v} \times \frac{{N}_{3}}{R} ⌉ ⌉ \} .$$

The CSI part-1 may comprise an indicator of an RS resource corresponding to a strongest co-efficient among co-efficients. “Indicator of RS resource corresponding to strongest co-efficient” can be included in CSI part-2 (e.g., first group, or CSI part-2 group-0). This parameter can be used for determining the strongest coefficient and/or bit-size of CSI groups in CSI part-2. The bitwidth of “Indicator of CSI-RS resource corresponding to strongest co-efficient” can be ┌log₂(N_{RS})┐.

In some embodiments, Pᵥ and beta (β) can be TRP-common (e.g., same value(s) can be associated with each of CSI-RS) and without further indication in the CSI report. A maximum number of non-zero coefficients summed for one layer (e.g., across all RS resources used for deriving CSI) can be determined according to the following:

$$⌈ ( {\sum }_{i ∈ Set of used RS ( s )} 2 {L}_{i , J} ) {M}_{x} β ⌉ , or ⌈ 2 {L}_{J}^{Total} {M}_{x} β ⌉ .$$

A maximum number of non-zero coefficients summed across all layers (e.g., across all RS resources used for deriving CSI) can be determined according to the following:

$$2 \times ⌈ ( {\sum }_{i ∈ Set of used RS ( s )} 2 {L}_{i , J} ) {M}_{x} β ⌉ , or ⌈ 2 {L}_{J}^{Total} {M}_{x} β ⌉ .$$

The set of used RS(s) (e.g., selected TRP/CSI-RS) can be determined according to the indicator of selected RS resource(s), if present. The J can be determined according to the indicator of parameter combination. L_{J}^{Total} may denote a total number of SD-bases across CSI-RS resources in a set for J-th parameter combination

$$( e . g . , {L}_{J}^{Total} = {\sum }_{i = 1 , … , {N}_{RS}} 2 {L}_{i , J} ) .$$

Furthermore,

$${M}_{x} = ⌈ {P}_{v} \times \frac{{N}_{3}}{R} ⌉ or {M}_{x} = ⌈ {P}_{m} \times \frac{{N}_{3}}{R} ⌉ ,$$

where Pᵥ and Pₘ may denote a FD-basis factor for the indicated rank in the CSI report and a FD-basis factor under a given rank of m (e.g., rank can be assumed as m=1).

In some embodiments, Pᵥ and beta (β) can be TRP-specific (e.g., individual value associated with each of CSI-RS). A maximum number of non-zero coefficients summed for one layer (e.g., across all RS resources used for deriving CSI) can be determined according to the following:

$$⌈ ( {\sum }_{i ∈ Set of used RS ( s )} 2 {L}_{i , J} {M}_{i , J , x} {β}_{i , J} ) ⌉ .$$

A maximum number of non-zero coefficients summed across all layers (e.g., across all RS resources used for deriving CSI) can be determined according to the following:

$$2 \times ⌈ ( {\sum }_{i ∈ Set of used RS ( s )} 2 {L}_{i , J} {M}_{i , J , x} {β}_{i , J} ) ⌉ .$$

The set of used RS(s) (e.g., selected TRP) can be determined according to a CSI-RS resource indicator, if present, and J can be determined according to the indicator of parameter combination.

Furthermore,

$${M}_{i , J , x} = ⌈ {P}_{i , J , v} \times \frac{{N}_{3}}{R} ⌉ or {M}_{i , J , x} = ⌈ {P}_{i , J , m} \times \frac{{N}_{3}}{R} ⌉ .$$

P_{i,J,v} and P_{i,J,m} may denote a FD-basis factor of the indicated rank in the CSI report, i-th RS, and J-th parameter combination (being used), a FD-basis factor of i-th RS and J-th parameter combination (being used) under a given rank of m (e.g., rank can be assumed as m=1).

In some embodiments, in CSI-RS part 2, a number of non-zero coefficients summed across all layers per selected RS resource may be provided individually (e.g., Indicator of the number of non-zero coefficients for a selected RS resource).

For i-th CSI-RS resource (e.g., from 1^{st} to N_{UsedRS}−1th). The last one can be calculated accordingly. If max allowed rank is 1, the corresponding the bitwidth can be ┌log₂(K₀)┐. Otherwise, the bitwidth can be ┌log₂(2K₀)┐. Furthermore, the field of ‘the number of non-zero coefficients summed across all layers per selected CSI-RS resource’ can be absent, if the following condition is satisfied: the number of selected CSI-RS or CSI-RS in a set is 1.

For instance, Table 2 illustrates an example precoding parameters in CSI part 1 in CJT, based on the above analysis, besides for subband/wideband CQI and RI.

TABLE 2

| | |
|---|---|
| Precoding | Indicator of selected RS resource(s), e.g., by a bitmap (e.g., |
| parameters in CSI- | up to 4-bit): |
| Part 1 | Bitwidth: NRS-bit, if the number of CSI-RS resource(s) in a |
| | CMR set for channel measurement is greater than one; 0-bit, |
| | otherwise |
| | Indicator of parameter combination, e.g., to be associated |
| | with the CSI or to be used in the CSI |
| | Bitwidth: ┌log₂ (N_{L})┐ − bit |
| | Indicator of the number of non-zero coefficients, i.e., KNZ |
| | (e.g., total number of non-zero coefficients summed across |
| | all layers across all selected RS(s) used for deriving CSI) |
| | Bitwidth: as mentioned-above |
| | Indicator of RS resource corresponding to strongest co- |
| | efficient |
| | Bitwidth: ┌log₂ (N_{RS})┐ |

### Implementation Example 3: Report Format for CSI Part-2

In this implementation example, details about report format for CSI part-2 are elaborated. For CSI part-2, S groups can be included. S can be a positive integer (e.g., S=3 or 4).

For instance, the CSI part-2 may have four groups for a given CSI report as shown in Table 3. In some embodiments, there can be CSI omission priority rules for respective groups.

CSI-Part2 group-0 can be prioritized over CSI-Part2 group-1, CSI-Part2 group-2 or CSI-Part2 group-3.

CSI-Part2 group-1 can be prioritized over CSI-Part2 group-2 or CSI-Part2 group-3.

CSI-Part2 group-2 can be prioritized over CSI-Part2 group-3.

TABLE 3

| | |
|---|---|
| CSI-Part-2 | CSI-Part 2 group-0 |
| | CSI-Part 2 group-1 |
| | CSI-Part 2 group-2 |
| | CSI-Part 2 group-3 |

A first group in CSI part-2 (e.g., CSI-Part 2 group-0) may include at least one of: at least one indicator of selected spatial-domain (SD) bases, an indicator of a RS resource corresponding to a strongest co-efficient among co-efficients, an indicator of a spatial-domain (SD) basis corresponding to a strongest co-efficient among co-efficients, or an indicator of one or more RS resources for a t-th group.

The first group in CSI part-2 may include at least one indicator of selected spatial-domain (SD) bases. The at least one indicator of selected spatial-domain (SD) bases can be for respective RS resource(s) used for CSI determination. In some embodiments, there can be N_{UsedRS} indicators of selected SD bases for each of RS resource(s) used for CSI determination. For instance, when Indicator of selected RS resource(s) is present in the CSI report, an indicator of selected SD bases for i-th RS resource may belong to the set of i-th selected RS indicated by “Indicator of selected RS resource(s)”.

In some embodiments, an indicator of selected SD bases may comprise at least one of an indicator of rotation factor for SD basis and an indicator of SD-basis combination (e.g., by a mechanism of combination number).

A bitwidth for an indicator of rotation factor for SD basis (e.g., i_{1,1,i}): ┌log₂(O₁O₂)┐-bit. The O₁ and O₂ may denote oversampling factors for vertical and horizontal axis, respectively.

A bitwidth for an indicator of SD-basis combination (e.g., i_{1,2,i}):

$$⌈ {log}_{2} ( \begin{matrix}{N}_{1} {N}_{2} \\ {L}_{i , J}\end{matrix} ) ⌉ - bit .$$

The N₁ and N₂ may denote a number of vertical and horizontal antenna elements, respectively. L_{i,J} may denote a determined the number of SD bases for i-th RS used for CSI determination.

The first group in CSI part-2 may include an indicator of a RS resource corresponding to a strongest co-efficient among co-efficients. For CSI part-2, this parameter can be used for determining the strongest coefficient and/or bit-size of CSI groups. In such case, when the indicator of SD basis is in the CSI part-2 (e.g., in CSI part-2 group-0), the bitwidth of “Indicator of CSI-RS resource corresponding to strongest co-efficient” can be ┌log₂(N_{UsedRS})┐.

The first group in CSI part-2 may include an indicator of a spatial-domain (SD) basis corresponding to a strongest co-efficient among co-efficients. “Indicator of RS resource corresponding to strongest co-efficient” can be in CSI part-1. “Indicator of SD basis corresponding to strongest co-efficient” can be in CSI part-2 (e.g., CSI part-2 group-0).

The bitwidth of “Indicator of CSI-RS resource corresponding to strongest co-efficient” can be ┌log₂(N_{RS})┐.

The bitwidth of “Indicator of SD basis corresponding to strongest co-efficient” can be ┌log₂(2Lᵢ)┐, ┌log₂(K^{NZ})┐, min{┌log₂(K^{NZ})┐, ┌log₂(2Lᵢ)┐}, or ┌log₂(min {K^{NZ},2Lᵢ}).

In certain embodiments, regardless of ranks, the bitwidth can always be ┌log₂(2Lᵢ)┐.

For rank-1, the bitwidth can be ┌log₂(K^{NZ})┐, min{┌log₂(K^{NZ})┐, ┌log₂(2Lᵢ)┐}, or log₂(min{K^{NZ},2Lᵢ})┐. Otherwise, the bitwidth can be ┌log₂(2Lᵢ)┐.

In some embodiments, both of “Indicator of RS resource corresponding to strongest co-efficient” and “Indicator of SD basis corresponding to strongest co-efficient” can be in CSI part-2. The bitwidth of “Indicator of RS resource corresponding to strongest co-efficient” can be ┌log₂(N_{UsedRS})┐. The bitwidth of “Indicator of SD basis corresponding to strongest co-efficient” can be

$${max}_{i ∈ Set of used RS ( s )} \{ ⌈ {log}_{2} ( 2 {L}_{i} ) ⌉ \} or ⌈ {log}_{2} ( {K}^{NZ} ) ⌉ - bit .$$

For rank-1, the bitwidth can be ┌log₂(K^{NZ})┐. Otherwise, the bitwidth can be

$${max}_{i ∈ Set of used RS ( s )} \{ ⌈ {log}_{2} ( 2 {L}_{i} ) ⌉ \} .$$

In some embodiments, there may be no “Indicator of RS resource corresponding to strongest co-efficient.” Only indicator(s) for “Indicator of SD basis corresponding to strongest co-efficient per layer” that is across different polarization across RS resource(s) used for CSI determination can be included.

The bitwidth of “Indicator of SD basis corresponding to strongest co-efficient per layer” can be

$$⌈ {log}_{2} ( {\sum }_{i ∈ Set of Used RS ( s )} 2 {L}_{i} ) ⌉ or ⌈ {log}_{2} ( {K}^{NZ} ) ⌉ .$$

or ┌log₂(K^{NZ})┐.

For rank-1, the bitwidth can be ┌log₂(K^{NZ})┐. Otherwise, the bitwidth can be

$$⌈ {log}_{2} ( {\sum }_{i ∈ Set of Used RS ( s )} 2 {L}_{i} ) ⌉ .$$

The first group in CSI part-2 may include an indicator of one or more RS resources for a t-th group. The one or more RS resource can be from the RS resource(s) used for CSI determination (e.g., for t-th group). t can be an integer, such as from 0 to 1.

The number of one or more CSI-RS(s) can be ┌N_{UsedRS}/T┐ or ┌N_{UsedRS}/T┐. T can be a total number of groups (e.g., 2). Each of T groups may have individual priority levels in terms of CSI omission. When T=2, the indicator can be achieved by a bitmap (i.e., bit=1) or a combination number with bitwidth of

$$⌈ {log}_{2} ( \begin{matrix}{N}_{UsedRS} \\ {N}_{t}\end{matrix} ) ⌉$$

bit. The bitwidth of the bitmap can be the number of used RS. Nₜ may denote a number of RSs for t-th group. The rest of selected CSI-RS may comprise the t=1 group. Furthermore, the indicator can be indicate one more RS resource(s) for s=0 group. The RS resource corresponding to strongest co-efficient can be in the s=0 group.

In some embodiments, the group with t=0 may comprise the RS resource corresponding to strongest co-efficients. The group with t=1 may comprise the rest of used CSI-RS(s).

FIG. 5 illustrates an example reference signal configuration for a coherent joint transmission channel state information report, in accordance with some embodiments of the present disclosure. There can be a NRS CSI-RS resource in a CSI-RS set for channel measurement for CJT. Based on the “Indicator of selected RS resource(s)” in CSI part-1, N_{UsedRS} CSI-RS resource(s) can be selected. In CSI-part-2, for facilitating CSI omission, the used RS resource(s) can be further divided into two groups. Precoding parameter(s) (e.g., parameter in CSI part-2 group-1/2) for t=0-th group can be prioritized over t=1 group. More details can be found in Implementation Example 4.

Table 4 illustrates example precoding parameters in the first group of CSI part 2 (e.g., CSI part-2 group-0) in CSI report format in CJT.

TABLE 4

| | |
|---|---|
| First group in | Indicator of selected spatial domain (SD) bases for 1-st used RS, |
| CSI part 2 | comprising an indicator of rotation factor for SD basis (e.g.,_{i1, 1, 1}), |
| (e.g., CSI part- | and an indicator of SD-basis combination (e.g., i_{1, 2, 1}). |
| 2 group-0) | . . . |
| | Indicator of selected spatial domain (SD) bases for N_{UsedRS}-th |
| | used RS, comprising an indicator of rotation factor for SD basis |
| | (e.g., i_{1, 1, N}_{_{—}}_{UsedRS}), and an indicator of SD-basis combination (e.g., |
| | i_{1, 2, N}_{_{—}}_{UsedRS}). |
| | Indicator of SD basis corresponding to strongest co-efficient (i.e., |
| | across polarizations per layer) |
| | Indicator of RS resource corresponding to strongest co-efficient |
| | Indicator of one or more RS resources for t-th group for CSI |
| | omission. |

A second group in CSI part-2 (e.g., CSI-Part 2 group-1) may include at least one of: an indicator of one or more selected frequency-domain (FD) bases, an indicator of a window of one or more selected frequency-domain (FD) bases, an indicator of an offset of one or more frequency-domain (FD) bases, reference amplitudes for layer l, a first group of amplitude values for non-zero coefficients, a first group of phase values for non-zero coefficients, or a first group of indicators for non-zero coefficients.

The second group in CSI part-2 may include an indicator of one or more selected frequency-domain (FD) bases. The indicator of one or more selected frequency-domain (FD) bases can be i_{1,6,l}.

In some embodiments, the indicator of selected FD bases can be provided per layer l. The indicator of selective FD bases may comprise: N_{Used-RS} indicators of selective FD bases. Each of the indicator of selective FD bases may correspond to the selected RS by order. The indicator of selected FD bases can be provided per RS used for CSI determination. For RANK-v transmission, if N3<=a threshold (e.g., 19), a bitwidth can be

$$⌈ {log}_{2} ( \begin{matrix}{N}_{3} - 1 \\ {M}_{v} - 1\end{matrix} ) ⌉ or ⌈ {log}_{2} ( \begin{matrix}{N}_{3} \\ {M}_{v}\end{matrix} ) ⌉$$

bit; otherwise, if N3>a threshold (e.g., 19), a bitwidth can be

$$⌈ {log}_{2} ( \begin{matrix}2 {M}_{3} - 1 \\ {M}_{v} - 1\end{matrix} ) ⌉ or ⌈ {log}_{2} ( \begin{matrix}2 {M}_{3} \\ {M}_{v}\end{matrix} ) ⌉$$

bit.

In some embodiments, if the RS used for CSI determination is indicated by “indicator of RS resource corresponding to strongest co-efficient”, a biwidth can be

$$⌈ {log}_{2} ( \begin{matrix}2 {M}_{3} - 1 \\ {M}_{v} - 1\end{matrix} ) ⌉ or ⌈ {log}_{2} ( \begin{matrix}{N}_{3} - 1 \\ {M}_{v} - 1\end{matrix} ) ⌉$$

bit, due to the fact that the reference FD basis is assumed as 0; otherwise, a bitwidth can be

$$⌈ {log}_{2} ( \begin{matrix}{N}_{3} \\ {M}_{v}\end{matrix} ) ⌉ or ⌈ {log}_{2} ( \begin{matrix}2 {M}_{3} \\ {M}_{V}\end{matrix} ) ⌉$$

bit.

The second group in CSI part-2 may include an indicator of a window of one or more selected frequency-domain (FD) bases. This indicator can be reported if the number of subbands (e.g., N3) can be greater than or equal to a threshold (e.g., 19). The indicator of the window of selected FD bases can be provided for each of selected RSs. The indicator can be applied to all layers (e.g., layer-common, i_{1,5}), or provided per layer, layer-specific (e.g., i_{1,5,1}). For RANK-v transmission, a bitwidth can be ┌log₂(2Mᵥ)┐-bit, where

$${M}_{v} = ⌈ {p}_{v} \frac{{N}_{3}}{R} ⌉ .$$

The second group in CSI part-2 may include an indicator of an offset of one or more frequency-domain (FD) bases. The indicator(s) of an offset for a used RS resource can provide an offset of reference FD bases between a used RS resource and a reference RS resource. In some embodiments, the indicator(s) of offset for a used RS resource can provide the offset of the window of selected FD bases between the used RS resource and the reference RS resource. The indicator(s) can be provided for one of selected RS except for the reference RS resource. The indicator of offset can be used-RS specific. In such case, the number of the indicators can be “the number of selected RS−1” (e.g., N_{UsedRS}−1).

In some embodiments, the reference RS resource may correspond to the strongest co-efficient. The reference RS resource can be indicated by the indicator of SD basis corresponding to strongest co-efficient or by the indicator of RS resource corresponding to strongest co-efficient. The bitwidth can be ┌log₂(┌N₃/R┐)┐-bit. In some embodiments, the bitwidth can be ┌log₂(┌N₃×b┐)┐-bit, where b can be an integer (e.g., 1, 2, 3, or 4) or provided in the configuration.

The candidate value of the indicator of offset between reference FD bases can be from 0 to ┌N₃/R┐−1. The candidate value of the at least one indicator of offset between reference FD bases can be from a range of 0 to N₃₋₁/b or from a range of 0 to N₃b−1.

In certain embodiments, an indicator of an offset of one or more frequency-domain (FD) bases can be also called as “an indicator of an offset between reference FD windows for i-th selected RS and the reference RS resource.”

The second group in CSI part-2 may include reference amplitudes for layer l. There can be at least one of the following.

Option-1: Reference amplitude for layer l may correspond to a subset of a precoding matrix (W2) which is associated with another polarization different from that indicated by “Indicator of SD basis corresponding to strongest co-efficient.”

Option-2: Reference amplitude for layer/may comprise a reference amplitude for layer l for selected CSI-RS for each polarization, except for the polarization indicated by “Indicator of SD basis corresponding to strongest co-efficient.”

The second group in CSI part-2 may include a first group of amplitude values for non-zero coefficients. The first group of amplitude values for non-zero coefficient (e.g., i_{2,4,l,t}) can be determined according to a priority function.

For rank-v CSI, a number of amplitude values in the first group can be ┌K^{NZ}/2┐−v. The bitwidth of the first group can be (┌K^{NZ}/2┐−v)×Bₐₚ, where Bₐₚ can be a positive number and may denote the bitwidth for an amplitude value (e.g., 3-bit). The first group (e.g., (┌K^{NZ}/2┐−v)×Bₐₚ-bit) may have a higher priority based on the priority function.

The second group in CSI part-2 may include a first group of phase values for non-zero coefficients. The first group of phase values for non-zero coefficients (e.g., i_{2,5,l,t}) can be determined according to a priority function.

For rank-v CSI, the number of phase values in the first group can be ┌K^{NZ}/2┐−v. The bitwidth of the first group can be (┌K^{NZ}/2┐−v)×Bₚₕ, where Bₚₕ can be a positive number and may denote the bitwidth for an amplitude value (e.g., 4-bit). The first group (e.g., (┌K^{NZ}/2┐−v)×Bₚₕ-bit) may have a higher priority based on the priority function.

The second group in CSI part-2 may include a first group of indicators for non-zero coefficients. The first group of indicators for non-zero coefficients (i_{1,7,l,t}) can be determined according to a priority function. For rank-v CSI, the size of bitmap corresponding to the first group of indicators for non-zero coefficients can be v×2LMᵥ−└K^{NZ}/2┘. The first group (e.g., v×2LMᵥ−└K^{NZ}/2┘-bit) may have a higher priority based on the priority function.

In some embodiments, the first group may comprise at least one of amplitude values corresponding the RS resource indicated by at least one of the following: an indicator of one or more RSs from used RS(s) (e.g., indicator of one or more RS resources for 1-th group) or a CSI-RS corresponding to the strongest coefficient (e.g., determined according to indicator of CSI-RS resource corresponding to strongest co-efficient).

Table 5 illustrates example precoding parameters in second group in CSI part 2 (e.g., CSI part-2 group-0) in CSI report format for CJT.

TABLE 5

| | |
|---|---|
| CSI-Part2 | Indicator of selected frequency domain (FD) bases, e.g., i_{1, 6, 1}, for |
| group-1 | each layer 1. |
| | The indicator of selective FD bases may comprise: NUsedRS |
| | indicators of selective FD bases, each of which may correspond to |
| | the used RS by order. |
| | The indicator of selected FD bases can be provided per selected |
| | CSI-RS. |
| | Indicator of the window of selected FD bases |
| | This indicator can be reported if the number of subbands, e.g., |
| | N3, is greater than or equal to a threshold, e.g., 19. |
| | The indicator of the window of selected FD bases can be provided |
| | per selected CSI-RS. |
| | This indicator can be layer-common, e.g., i_{1, 5}, or layer-specific, |
| | e.g., i_{1, 5, 1} |
| | Indicator(s) of offset of FD bases, e.g., for i-th used RS (except |
| | for the reference RS resource) and the reference RS resource. |
| | The reference RS resource may correspond to strongest co- |
| | efficient. |
| | This indicator can be layer-common or layer-specific. |
| | Reference amplitudes for layer 1 |
| | First group of amplitude values for non-zero coefficients, e.g., |
| | i_{2, 4, 1, t}, determined according to a priority function. |
| | First group of phase values for non-zero coefficients, e.g., i_{2, 5, 1, t}, |
| | determined according to a priority function. |
| | First group of indicators for non-zero coefficients, e.g., i_{1, 7, 1, t}, |
| | determined according to a priority function. |

A third group in CSI part-3 (e.g., CSI-Part 2 group-2) may include at least one of: a second group of amplitude values for non-zero coefficients, a second group of phase values for non-zero coefficients, or a second group of indicators for non-zero coefficients.

The third group in CSI part-3 may include a second group of amplitude values for non-zero coefficients. The second group of amplitude values for non-zero coefficients (e.g., i_{2,4,l,t}) can be determined according to a priority function.

For rank-v CSI, a number of amplitude values in the first group can be └K^{NZ}/2┘. A bitwidth of the first group can be └K^{NZ}/2┘×Bₐₚ, where Bₐₚ can be a positive number and may denote the bitwidth for an amplitude value (e.g., 3-bit). The second group (e.g., └K^{NZ}/2┘×B-bit) may have a lower priority based on the priority function.

The third group in CSI part-3 may include a second group of phase values for non-zero coefficients. The second group of phase values for non-zero coefficients (e.g., i_{2,5,l,t}) can be determined according to a priority function. For rank-v CSI, a number of phase values in the first group can be └K^{NZ}/2┘. The bitwidth of the first group can be (└K^{NZ}/2┘−v)×Bₚₕ, where Bₚₕ can be a positive number and may denote the bitwidth for an amplitude value (e.g., 4-bit). The second group (e.g., (└K^{NZ}/2┘−v)×Bₚₕ-bit) may have a lower priority based on the priority function.

The third group in CSI part-3 may include a second group of indicators for non-zero coefficients. The second group of indicators for non-zero coefficients (e.g., i_{1,7,l,t}) can be determined according to a priority function. For rank-v CSI, the size of bitmap corresponding to the second group of indicators for non-zero coefficients can be └K^{NZ}/2┘. The second group (e.g., └K^{NZ}/2┘-bit) may have a higher priority based on the priority function.

TABLE 6

| | |
|---|---|
| CSI-Part2 | Second group of amplitude values for non-zero coefficients, e.g., |
| group-2 | i_{2, 4, 1, s}, determined according to a priority function. |
| | Second group of phase values for non-zero coefficients, e.g., |
| | i_{2, 5, 1, s}, determined according to a priority function. |
| | Second group of indicators for non-zero coefficients, e.g., i_{1, 7, 1, s}, |
| | determined according to a priority function. |

In some embodiments, there can be N+1 CSI-Part 2 groups, corresponding t-th group of amplitude values for non-zero coefficients, phase values for non-zero coefficients, or indicators for non-zero coefficients, for respective one of last N or T CSI-Part 2 groups in order (e.g., N=T).

The size of “s-th group of amplitude values for non-zero coefficients and/or phase values for non-zero coefficients or indicators for non-zero coefficients” can be pre-determined according to CSI-Part-1 or CSI-Part-2-group-0. The corresponding values can be mapped to the respective groups based on the priority rules. For instance, there can be 4 CSI-Part2 groups (e.g., group-0, group-1, . . . , group-3). Three groups of amplitude values for non-zero coefficients, phase values for non-zero coefficients, or/and indicators for non-zero coefficients, for respective group-1, group-2, and group-3 can be included.

### Implementation Example 4: CSI Omission Rule

When a CSI report for CJT is carried on a PUSCH, a UE may omit a portion of Part 2 CSI if the CSI report cannot be fully carried in the PUSCH. There can be S groups in the CSI-part-2. i-th groups in CSI part-2 can be prioritized over j-th groups in CSI part-2, wherein i<j. For instance, a first group can be prioritized over second and third groups in CSI part-2.

In a given CSI report for CJT, a priority rule can be CSI-Part 2 group-0>CSI-Part 2 group-1>CSI-Part 2 group-2 (e.g., CSI-Part 2 group-0 can be prioritized over CSI Part 2 group-1, and CSI Part 2 group-1 can be prioritized over CSI Part 2-group-2).

In a given CSI report for CSJ, a priority rule can be CSI-Part 2 group-0>CSI-Part 2 group-1>CSI-Part 2 group-2>CSI-Part 2 group-3. CSI-Part 2 group-0 can be prioritized over CSI Part 2 group-1. CSI Part 2 group-1 can be prioritized over CSI Part 2-group-2). CSI Part 2 group-2 can be prioritized over CSI Part 2 group-3.

For CSI-Part 2, bits for amplitude values for non-zero coefficients, phase values for non-zero coefficients, and indicator for non-zero coefficients based on a priority function may be prioritized.

The non-zero coefficient (regardless of amplitude value, phase value and indicator bitmap) with the highest priority may have the lowest associated value Pri(l, i, f, t). The priority function Pri(l, i, f, t), where l, i, f, t may denote the index of layer (e.g., l=1, 2, . . . , v), the index of SD-basis (e.g., i=0,1, . . . , 2L−1), the index of SD-basis (e.g., i=0,1, . . . , 2L−1), the index of FD-bases (e.g., f=0,1, . . . , Mᵥ₋₁), the index of group of one or more RS resource(s) (e.g., t=0, 1, or, t=0, 1 . . . , N_{UsedRS}, or t=0, 1 . . . , N_{RS}). The index of group of one or more RS resource(s) (e.g., t=0, 1, or, t=0, 1 . . . , N_{UsedRS}, or t=0, 1 . . . , N_{RS}) can be prioritized over at least one of the index of layer (e.g., l=1, 2, . . . , v), the index of SD-basis (e.g., i=0, 1, . . . , 2L−1), the index of SD-basis (e.g., i=0, 1, . . . , 2L−1), or the index of FD-bases. For instance, the index of group of one or more RS resource(s) can be prioritized over all of the index of layer (e.g., 1=1, 2, . . . , v), the index of SD-basis (e.g., i=0, 1, . . . , 2L−1), the index of SD-basis (e.g., i=0,1, . . . , 2L−1), and the index of FD-bases.

In some embodiments, the priority function can be determined according to at least one of 2*L*v*Mv*t, 2*L*v*t, or v*t.

In certain embodiments, the priority function can be determined according to the following: Pri(l, i, f, t)=2L·v·Mᵥ·t+2L·v·π(f)+v·i+l.

It should be understood that one or more features from the above implementation examples are not exclusive to the specific implementation examples, but can be combined in any manner (e.g., in any priority and/or order, concurrently or otherwise).

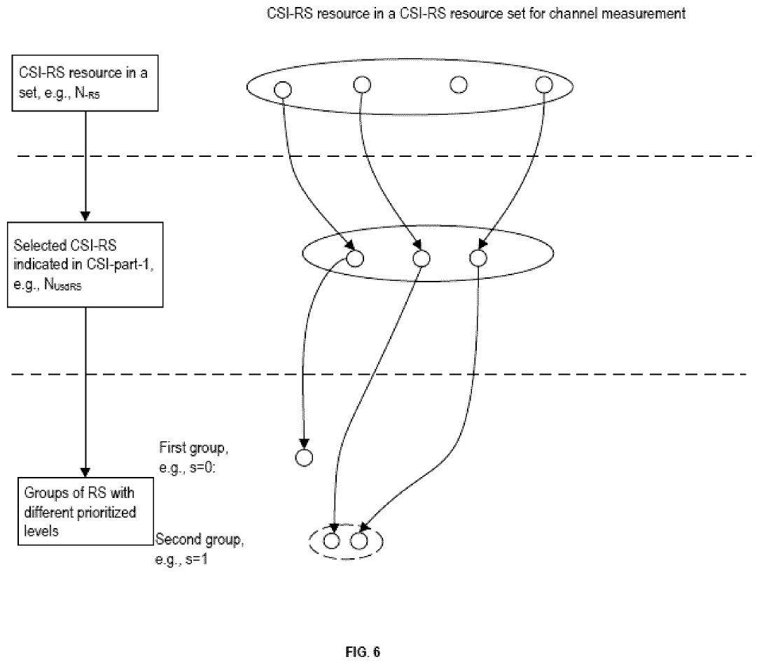

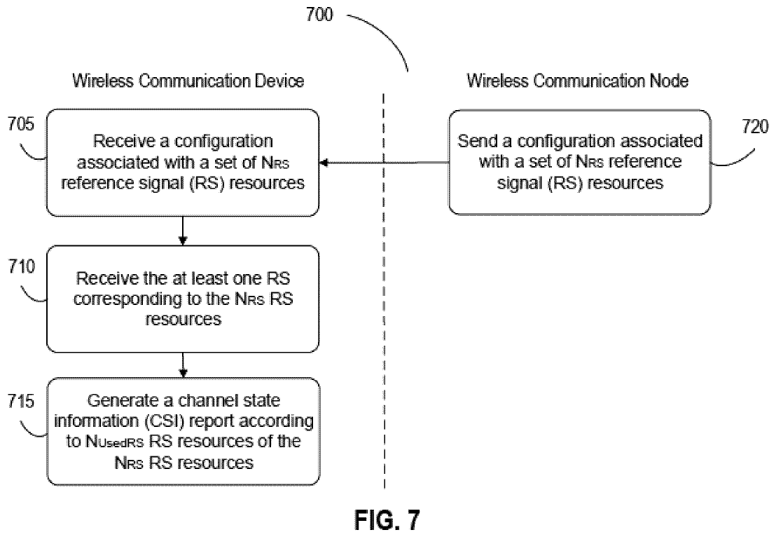

FIG. 7 illustrates a flow diagram of a method 700 for channel state information (CSI) report format and omission rule in coherent joint transmission (CJT). The method 700 may be implemented using any one or more of the components and devices detailed herein in conjunction with FIGS. 1-6. In overview, the method 700 may be performed by a wireless communication device, in some embodiments. Additional, fewer, or different operations may be performed in the method 700 depending on the embodiment. At least one aspect of the operations is directed to a system, method, apparatus, or a computer-readable medium.

A wireless communication device (e.g., a UE) may receive a configuration (e.g., a CSI report configuration) associated with a set of N_{RS} reference signal (RS) resources from a wireless communication node (e.g., a BS). N_{RS} can be a positive integer value. The wireless communication device may receive the at least one RS corresponding to the N_{RS} RS resources from the wireless communication node. The wireless communication device may generate a channel state information (CSI) report according to N_{UsedRS} RS resources of the N_{RS} RS resources. The CSI report may comprise a first part and a second part. N_{UsedRS} can be a positive integer value. The wireless communication device may send the CSI report to the wireless communication node.

In some embodiments, one RS resource of the N_{RS} RS resources can be associated with a ratio of an energy per resource element (EPRE) of a physical downlink shared channel (PDSCH) to an EPRE of a corresponding RS. The CSI can be determined based on a condition that the PDSCH is transmitted on antenna ports of the N_{UsedRS} RS resources, according to the ratio. Whether N_{UsedRS} is equal to N_{RS}, or is less than or equal to N_{RS}, can be determined according to a report mode parameter in the configuration. The N_{UsedRS} RS resources can be each associated with a same ratio of an EPRE of the PDSCH to an EPRE of the corresponding RS. When the report mode parameter is configured to be a first mode, at least one of: N_{UsedRS} can be equal to N_{RS}; or CSI can be determined according to all of the N_{RS} resources. When the report mode parameter is configured to be a second mode, at least one of: N_{UsedRS} can be less than or equal to N_{RS}; or the wireless communication device can be to indicate (e.g., using a CSI-RS resource indicator via a bitmap corresponding to the CSI-RS resource(s) in the set) the N_{UsedRS} RS resources of the N_{RS} RS resources in the CSI report, and the CSI can be determined according to the N_{UsedRS} RS resources.

In some embodiments, the first part may comprise an indicator of the N_{UsedRS} RS resources selected from of the N_{RS} RS resources. The indicator may comprise a bitmap. A bit size of the bitmap can be determined according to N_{RS}. Bits of the bitmap from most significant bit (MSB) to least significant bit (LSB) can be mapped to the N_{RS} RS resources in order of increasing or decreasing RS resource identifiers (IDs) or RS resource order. A first value (e.g., bit value 1) of a bit of the bitmap may indicate that a corresponding RS resource is selected. A second value (e.g., bit value 0) of the bit may indicate that the corresponding RS resource is not selected. At least one criterion for selecting RS resources, that is configured in the configuration (e.g., CSI report configuration), may comprise at least one of: a maximum number of RS resources in the set is to be selected, a minimum number of RS resources in the set is to be selected, one or more first combinations of RS resources from the set cannot be selected, or one or more second combinations of RS resources from the set can be selected.

In some embodiments, a field of the indicator of the N_{UsedRS} RS resources can be absent or may have zero bit size, when at least one of: a radio resource control (RRC) parameter is configured to indicate that all N_{RS} RS resources are to be used for CSI determination, a RRC parameter is configured to indicate that selection of RS resources for CSI determination is disabled, the N_{RS} RS resources consist of one RS resource for channel measurement, or N_{RS}=1. A field of the indicator of the N_{UsedRS} RS resources can be present, when at least one of: a radio resource control (RRC) parameter is configured to indicate that all or a subset of N_{RS} RS resources are to be used for CSI determination, a RRC parameter is configured to indicate that selection of RS resources for CSI determination is enabled, the N_{RS} RS resources comprise more than one RS resource for channel measurement, or N_{RS} is greater than 1.

In some embodiments, the first part may comprise an indicator of a combination of parameters to be selected from a set of combinations of parameters. The combination of parameters may comprise at least one of: a number of spatial-domain (SD) bases for each of the N_{RS} RS resources, a frequency-domain (FD) basis factor, or a non-zero coefficient factor. A bitwidth of the indicator can be ┌log₂(N₂)┐, where NL can be a number of combinations of parameters in the set. Capability reporting for the wireless communication device may include at least one of: a maximum number of combinations of parameters, to be configured in the configuration, a maximum number of selected SD bases across the N_{RS} RS resources, or a maximum number of selected SD bases across the N_{UsedRS} RS resources.

In some embodiments, the first part may comprise an indicator of a number of non-zero coefficients (K^{NZ}). The indicator can be determined across the N_{RS} RS resources or the N_{UsedRS} RS resources. The indicator can be provided for each of the N_{RS} RS resources or the N_{UsedRS} RS resources. A bitwidth of the indicator can be determined according to at least one of: a combination of parameters, K₀ or maximum allowed rank. The K₀ can be determined according to a function of M or β, can be determined according to a function of selecting maximum values, or can be determined across the N_{RS} RS resources or the N_{UsedRS} RS resources. The combination of parameters may comprise a selected combination. The combination of parameters may include at least one of: a number of spatial-domain (SD) bases for each of the N_{RS} RS resources, a frequency-domain (FD) basis factor, or a non-zero coefficient factor. When the maximum allowed rank is 1, the bitwidth of the indicator can be ┌log₂(K₀)┐. When the maximum allowed rank is not 1, the bitwidth of the indicator can be ┌log₂(2K₀)┐.

In some embodiments, the indicator can be provided for each of the N_{RS} RS resources or the N_{UsedRS} RS resources, wherein at least one of: when the maximum allowed rank is 1, the bitwidth of the indicator for i-th RS resource can be ┌log₂(K₀)┐, min{┌log₂(K₀)┐, ┌2L_{i,j}┌Pᵥ×N₃/R┐┐}, or

$$min \{ ⌈ {log}_{2} ( {K}_{0} ) ⌉ , ⌈ 2 {L}_{i , J} ⌈ {P}_{m} \times \frac{{N}_{3}}{R} ⌉ ⌉ \} ;$$

or when the maximum allowed rank is not 1, the bitwidth of the indicator for i-th RS resource can be ┌log₂(2K₀)┐, or

$$min \{ ⌈ {log}_{2} ( 2 {K}_{0} ) ⌉ , ⌈ 2 {L}_{i , J} ⌈ {P}_{v} \times \frac{{N}_{3}}{R} ⌉ ⌉ \} .$$

K₀ can be determined according to:

$${K}_{0} = {max}_{j ∈ \{ 1 , … , {N}_{L} \}} ⌈ 2 {L}_{j}^{Total} {M}_{x} β ⌉ ,$$

and wherein

$${M}_{x} = ⌈ {P}_{v} \times \frac{{N}_{3}}{R} ⌉ or {M}_{x} = ⌈ {P}_{m} \times \frac{{N}_{3}}{R} ⌉ ,$$

where Pₘ may denote a FD-basis factor under a given rank of m; or Pᵥ may denote a FD-basis factor for the indicated rank in the CSI report, and Lⱼ^{Total} may denote a total number of spatial-domain (SD) basis across the N_{RS} RS resources for j-th combination of parameters, or

$${L}_{j}^{Total} = {\sum }_{i = 1 , … , {N}_{RS}} 2 {L}_{i , j} .$$

In some embodiments, K₀ can be determined according to:

$${K}_{0} = {max}_{j ∈ \{ 1 , … , {N}_{L} \}} ⌈ ( {\sum }_{i = 1 , … , {N}_{RS}} 2 {L}_{i , j} {M}_{i , j , x} {β}_{i , j} ) ⌉ ,$$

and wherein

$${M}_{i , j , x} = ⌈ {P}_{i , j , v} \times \frac{{N}_{3}}{R} ⌉ or {M}_{i , j , x} = ⌈ {P}_{i , j , m} \times \frac{{N}_{3}}{R} ⌉ ,$$

where P_{i,j,v} and P_{i,j,m} may denote a FD basis factor of the indicated rank in the CSI report, i-th RS, and j-th combination of parameters, a FD basis factor of the i-th RS and the j-th combination under an indicated rank or a given rank of m, respectively. In some embodiments, the first part may comprise an indicator of an RS resource corresponding to a strongest co-efficient, and wherein a bitwidth of the indicator can be ┌log₂(N_{RS})┐.

In some embodiments, a same value of Pᵥ and a same value of beta (β), can be each associated with each of the RSes. A maximum number of non-zero coefficients summed for one layer can be determined according to:

$$⌈ ( {\sum }_{i ∈ Set of used RS ( s )} 2 {L}_{i , J} ) {M}_{x} β ⌉ , or ⌈ 2 {L}_{J}^{Total} {M}_{x} β ⌉ ;$$

or a maximum number of non-zero coefficients summed across all layers can be determined according to:

$$2 \times ⌈ ( {\sum }_{i ∈ Set of used RS ( s )} 2 {L}_{i , J} ) {M}_{x} β ⌉ , or ⌈ 2 {L}_{J}^{Total} {M}_{x} β ⌉ ,$$

or 2×┌2L_{J}^{Total}Mₓβ┐, where ‘Set of used RS(s)’ can be determined according the N_{UsedRS} RS resources, and J may correspond to the combination of parameters used for CSI determination; L_{J}^{Total} may denote a total number of spatial-domain (SD) bases across the N_{RS} RS resources for a J-th combination of parameters used for CSI determination, or

$${L}_{J}^{Total} = {\sum }_{i = 1 , … , {N}_{R S}} 2 {L}_{i , J} , {M}_{x} = ⌈ {P}_{v} \times \frac{{N}_{3}}{R} ⌉ or {M}_{x} = ⌈ {P}_{m} \times \frac{{N}_{3}}{R} ⌉ ,$$

where Pᵥ and Pₘ may respectively denote a frequency-domain (FD) basis factor for an indicated rank in the CSI report, and a FD basis factor under a given rank of m.

In some embodiments, Pᵥ and β each may have an individual value associated with each of the N_{RS} RS resources. A maximum number of non-zero coefficients summed for one layer or across all the N_{RS} RS resources, can be determined according to:

$$⌈ ( {\sum }_{i ∈ Set of used RS ( s )} 2 {L}_{i , J} {M}_{i , J , x} {β}_{i , J} ) ⌉ ;$$

or a maximum number of non-zero coefficients summed across all layers or across all the N_{RS} RS resources, can be determined according to the following:

$$2 \times ⌈ ( {\sum }_{i ∈ Set of used RS ( s )} 2 {L}_{i , J} {M}_{i , J , x} {β}_{i , J} ) ⌉ ,$$

where ‘Set of used RS(s)’ can be determined according to the N_{UsedRS} RS resources, and J may correspond to the combination of parameters used for CSI determination;

$${M}_{i , J , x} = ⌈ {P}_{i , J , v} \times \frac{{N}_{3}}{R} ⌉ or {M}_{i , J , x} = ⌈ {P}_{i , J , m} \times \frac{{N}_{3}}{R} ⌉ ,$$

where P_{i,J,v} and P_{i,J,m} respectively may denote a FD basis factor of an indicated rank in the CSI report, i-th RS, and J-th combination of parameters, and a FD basis factor of the i-th RS and the J-th combination under a given rank of m.

In some embodiments, the second part may comprise a number of non-zero coefficients summed across all layers, provided for i-th RS resource. A bitwidth of the indicator, for i-th RS resource, can be determined according to K₀. When a maximum allowed rank is 1, a bitwidth for i-th RS resource can be ┌log₂(K₀)┐. When a maximum allowed rank is not 1, the bitwidth for the i-th RS resource can be ┌log₂(2K₀)┐. A field of ‘the number of non-zero coefficients summed across all layers for i-th RS resources’ can be absent, when N_{UsedRS} or N_{RS} is 1. The i-th RS resource may correspond to any of the N_{UsedRS} RS resources, except for the last one or first one.

In some embodiments, the second part may comprise S number of groups. S can be a positive integer. A first group of the second part may include at least one indicators of selected spatial-domain (SD) bases. There can be a number (N_{UsedRS}) of indicators of selected SD bases for each of the N_{UsedRS} RS resources. A first indicator, from the at least one indicators of selected SD bases, may comprise at least one of an indicator of rotation factor for SD basis and an indicator of SD basis combination. A first group of the second part may include an indicator of a RS resource corresponding to a strongest co-efficient, and a bitwidth of the indicator can be ┌log₂(N_{UsedRS})┐. A first group of the second part may include an indicator of a spatial-domain (SD) basis corresponding to a strongest co-efficient. The first part may include an indicator of a RS resource corresponding to a strongest co-efficient. A bitwidth of the indicator of the RS resource can be ┌log₂(N_{RS})┐. A bitwidth of the indicator of the SD basis can be ┌log₂(2Lᵢ)┐, ┌log₂(K^{NZ})┐, min{┌log₂(K^{NZ})┐, ┌log₂(2Lᵢ)┐} or ┌log₂(min{K^{NZ},2Lᵢ})┐. A bitwidth of the indicator of the SD basis can be ┌log₂(2Lᵢ)┐ regardless of rank. For rank-1, the bitwidth of the indicator of the SD basis can be ┌log₂(K^{NZ})┐, min{┌log₂(K^{NZ})┐, ┌log₂(2Lᵢ)┐} or ┌log₂(min {K^{NZ},2Lᵢ})┐. For other than rank-1, the bitwidth of the indicator of the SD basis can be ┌log₂(2Lᵢ)┐.

In some embodiments, the first group of the second part or the second part may include an indicator of a RS resource corresponding to a strongest co-efficient, and wherein at least one of: a bitwidth of the indicator of the RS resource can be ┌log₂(N_{UsedRS})┐; a bitwidth of the indicator of the SD basis can be

$${max}_{i ∈ Set of used RS ( s )} \{ ⌈ {log}_{2} ( 2 {L}_{i} ) ⌉ \} or ⌈ {log}_{2} ( {K}^{NZ} ) ⌉ - bit ;$$

for rank-1, the bitwidth of the indicator of the SD basis can be ┌log₂(K^{NZ})┐; or for other than rank-1, the bitwidth of the indicator of the SD basis can be

$${max}_{i ∈ Set of used RS ( s )} \{ ⌈ {log}_{2} ( 2 {L}_{i} ) ⌉ \} .$$

The indicator of the spatial-domain (SD) basis corresponding to the strongest co-efficient can be indicated across the N_{UsedRS} RS resources, and wherein the bitwidth of the indicator can be

$$⌈ {log}_{2} ( {\sum }_{i ∈ Set of used RS ( s )} 2 {L}_{i} ) ⌉ or ⌈ {log}_{2} ( {K}^{NZ} ) ⌉ .$$

In some embodiments, for rank-1, the bitwidth of the indicator can be ┌log₂(K^{NZ})┐, or for other than rank-1,

$$⌈ {log}_{2} ( {\sum }_{i ∈ Set of used RS ( s )} 2 {L}_{i} ) ⌉ .$$

In some embodiments, the CSI may comprise an indicator of one or more of the N_{UsedRS} RS resources for a RS group with an index of t, where t can be integer. The first group of the second part of the CSI may comprise the indicator of one or more of N_{UsedRS} RS resources. A number of the one or more of the N_{UsedRS} RS resources can be determined according to a function of T or N_{UsedRS}/T, or can be ┌N_{UsedRS}/T┐ or └N_{UsedRS}/T┘. T can be a total number of groups and can be a positive integer. The one or more of the N_{UsedRS} RS resources form a RS group with index of t=0, and rest of the N_{UsedRS} RS resources may form a RS group with index of t=1. The indicator may correspond to a bitmap, where the bitwidth can be a number of used RS resources. The indicator may corresponds to a combination number with a bitwidth of

$$⌈ {log}_{2} ( \begin{matrix}{N}_{Used RS} \\ {N}_{t}\end{matrix} ) ⌉$$

bit, where the bitwidth can be a number of used RS resources, and Nₜ may denote a number of RSs for the RS group with index of t. The combination number can be a single parameter (e.g., a value of 31) to point more than one parameter (e.g., a value of 6 and 1). For instance, the first value may equal to floor (X/5), and the second value may equal to X %5.

In some embodiments, a RS group with an index of t=0 may comprise a RS resource corresponding to a strongest co-efficient. A RS group with an index of t=1 may comprise rest of used RSs except for the RS resource corresponding to a strongest co-efficient. Each RS group may have a respective priority level in terms of CSI omission. A priority value for a non-zero coefficient corresponding to the RS group with index of t in terms of CSI omission can be determined according to t. The number of RS groups can be 2. A second group of the second part may include an indicator of one or more selected frequency-domain (FD) bases, wherein at least one of: the indicator may comprise a respective indicator provided for each of the N_{UsedRS} RS resources; for rank-v transmission, if N₃<=a threshold, the bitwidth can be

$$⌈ {log}_{2} ( \begin{matrix}{N}_{3} - 1 \\ {M}_{v} - 1\end{matrix} ) ⌉ or ⌈ {log}_{2} ( \begin{matrix}{N}_{3} \\ {M}_{v}\end{matrix} ) ⌉ - bit ;$$

for other than rank-v transmission, if N₃>the threshold, the bitwidth can be

$$⌈ {log}_{2} ( \begin{matrix}2 {M}_{3} - 1 \\ {M}_{v} - 1\end{matrix} ) ⌉ or ⌈ {log}_{2} ( \begin{matrix}2 {M}_{3} \\ {M}_{v}\end{matrix} ) ⌉ - bit ;$$

when a RS resource used for CSI determination is indicated by another indicator of RS resource corresponding to a strongest co-efficient among co-efficients, a bitwidth of the indicator can be

$$⌈ {log}_{2} ( \begin{matrix}2 {M}_{3} - 1 \\ {M}_{v} - 1\end{matrix} ) ⌉ or ⌈ {log}_{2} ( \begin{matrix}{N}_{3} - 1 \\ {M}_{v} - 1\end{matrix} ) ⌉ - bit ,$$

where a reference FD basis can be assumed as 0; or when a RS used for CSI determination is indicated by another indicator, the bitwidth of the indicator can be

$$⌈ {log}_{2} ( \begin{matrix}{N}_{3} \\ {M}_{v}\end{matrix} ) ⌉ - bit or ⌈ {log}_{2} ( \begin{matrix}2 {M}_{3} \\ {M}_{v}\end{matrix} ) ⌉ - bit .$$

In some embodiments, a second group of the second part may include an indicator of window of selected frequency-domain (FD) bases, wherein at least one of: the indicator of the window of selected FD bases may comprise a respective indicator provided for each of the N_{UsedRS} RS resources; or the indicator can be applied to all layers, or may comprise a respective indicator provided for each of the layers, or provided for a specific layer. A second group of the second part may include at least one indicator of offset of selected frequency-domain (FD) bases, wherein at least one of: the at least one indicator may provide an offset of reference FD bases between one of the N_{UsedRS} RS resources and a reference RS resource; the at least one indicator may provide an offset of FD bases between one of the N_{UsedRS} RS resources and a reference RS resource; the respective offset can be an offset of window of the selected FD bases between a respective RS resource and the reference RS resource; the at least one indicator can be provided for one of the N_{UsedRS} RS resources except for the reference RS resource, wherein a number of the at least one indicator can be (N_{UsedRS}−1); the reference RS resource may correspond to a strongest co-efficient, and can be determined according to an indicator of spatial-domain (SD) basis corresponding to the strongest co-efficient or an indicator of RS resource corresponding to the strongest co-efficient; bitwidth of the at least one indicator can be ┌log₂(┌N₃×b┐)┐-bit, where b can be a defined integer value or provided in the configuration; or a candidate value of the at least one indicator of offset between reference FD bases can be from a range of 0 to N₃−1/b or from a range of 0 to N₃b−1. A second group of the second part may include reference amplitudes for at least one specific layer.

In some embodiments, a second group of the second part may include at least one first group of amplitude values for at least one non-zero coefficient. A first group of amplitude values for a non-zero coefficient can be determined according to a priority function.

In some embodiments, a second group of the second part may include at least one first group of phase values for at least one non-zero coefficient. A first group of phase values for a non-zero coefficient can be determined according to a priority function. A second group of the second part may include at least one first group of indicators for at least one non-zero coefficient. A first group of indicators for a non-zero coefficient can be determined according to a priority function. The first group may comprise at least one amplitude value corresponding to a RS resource indicated by at least one of: an indicator of one or more RSs from the N_{UsedRS} RS resources; or an RS corresponding to a strongest coefficient.

In some embodiments, a third group of the second part may include at least one second group of amplitude values for at least one non-zero coefficient. A second group of amplitude values for a non-zero coefficient can be determined according to a priority function. A second group of the second part may include at least one second group of phase values for at least one non-zero coefficient. A second group of phase values for a non-zero coefficient can be determined according to a priority function.

In some embodiments, a second group of the second part may include at least one second group of indicators for at least one non-zero coefficient. A second group of indicators for a non-zero coefficient can be determined according to a priority function. For the S groups of the second part, there can be a corresponding t-th group of amplitude values for non-zero coefficients, of phase values for the non-zero coefficients, or of indicators for the non-zero coefficients, for each respective one of last S-1 or last S-2 groups of the second part, in order of the S groups. When the CSI report cannot be fully carried in physical uplink shared channel (PUSCH), the wireless communication device may omit a portion of the second part.

In some embodiments, a group of the second part may have a lower priority for omission (e.g., higher likelihood for being omitted) relative to another group that is earlier in order or has a lower group index in the second part. A higher priority may mean/indicate higher priority for transmission/keeping in the CSI report (rather than being omitted). The wireless communication device may prioritize bits for amplitude values for non-zero coefficients, for phase values for the non-zero coefficients, or for indicators for non-zero coefficients, according to a priority function, to be carried in the PUSCH. A non-zero coefficient having a highest priority may have a lowest associated value of the priority function. The priority function can be a function of: index of layer (l), index of spatial-domain (SD) basis (i), index of frequency-domain (FD) basis (f), or index of RS group of one or more RS resources (t). For determining a value of the priority function, the index of RS group can be more significant over at least one of: the index of layer, the index of SD basis, or the index of FD basis.

In some embodiments, when a number of layers is v, a number of SD basis is L, and a number of FD basis is Mv, the priority function may have a value determined according to one of: 2*L*v*Mv*t, or 2*L*v*t, or v*t. When a number of layers is v, a number of SD basis is L, and a number of FD basis is Mv, the priority function can be: Pri(l, i, f, t)=2L·v·Mᵥ·t+2L·v·π(f)+v·i+l.

In some embodiments, a wireless communication node (e.g., a BS) may send a configuration (e.g., a CSI report configuration) associated with a set of N_{RS} reference signal (RS) resources to a wireless communication device (e.g., a UE). N_{RS} can be a positive integer value. The wireless communication node may receive the at least one RS corresponding to the N_{RS} RS resources from the wireless communication device. The wireless communication device may generate according to N_{UsedRS} RS resources of the N_{RS} RS resources, a channel state information (CSI) report, the CSI report comprising a first part and a second part. N_{UsedRS} can be a positive integer value.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
receiving, by a wireless communication device from a wireless communication node, a configuration associated with a set of N_{RS} reference signal (RS) resources, where N_{RS} is a positive integer value;
receiving, by the wireless communication device from the wireless communication node, the at least one RS corresponding to the N_{RS} RS resources; and
generating, by the wireless communication device according to N_{UsedRS} RS resources of the N_{RS} RS resources, a channel state information (CSI) report, the CSI report comprising a first part and a second part, where N_{UsedRS} is a positive integer value.

2. The method of claim 1, wherein:
the N_{UsedRS} RS resources are each associated with a same ratio of an energy per resource element (EPRE) of a physical downlink shared channel (PDSCH) to an EPRE of a corresponding RS.

3. The method of claim 2, wherein, when the report mode parameter is configured to be a first mode,
N_{UsedRS} is equal to N_{RS};
or
when the report mode parameter is configured to be a second mode, at least one of:
N_{UsedRS} is less than or equal to N_{RS}; or
the wireless communication device is to indicate the N_{UsedRS} RS resources of the N_{RS} RS resources in the CSI report, and the CSI is determined according to the N_{UsedRS} RS resources.

4. The method of claim 1, wherein the first part comprises an indicator of the N_{UsedRS} RS resources selected from of the N_{RS} RS resources,
wherein at least one of:
the indicator comprises a bitmap, and a bit size of the bitmap is determined according to N_{RS}; or
bits of the bitmap from most significant bit (MSB) to least significant bit (LSB) are mapped to the N_{RS} RS resources in order of increasing or decreasing RS resource identifiers (IDs) or RS resource order.

5. The method of claim 4, wherein a field of the indicator of the N_{UsedRS} RS resources is absent or has zero bit size, when
a radio resource control (RRC) parameter is configured to indicate that all N_{RS} RS resources are to be used for CSI determination.

6. The method of claim 4, wherein a field of the indicator of the N_{UsedRS} RS resources is present, when at least one of:
a RRC parameter is configured to indicate that selection of RS resources for CSI determination is enabled, or
N_{RS} is greater than 1.

7. The method of claim 1, wherein the first part comprises an indicator of a combination of parameters to be selected from a set of combinations of parameters,
wherein at least one of:
the combination of parameters comprises at least one of: a number of spatial-domain (SD) bases for each of the N_{RS} RS resources; or
a bitwidth of the indicator is ┌log₂(N_{L})┐, where N_{L} is a number of combinations of parameters in the set.

8. The method of claim 1, wherein the first part comprises an indicator of a number of non-zero coefficients (K^{NZ}),
wherein at least one of:
the indicator is determined across the N_{UsedRS} RS resources; or
a bitwidth of the indicator is determined according to at least one of: a combination of parameters, or K₀.

9. The method of claim 8, wherein:
the combination of parameters includes a number of spatial-domain (SD) bases for each of the N_{RS} RS resources.

10. The method of claim 8, wherein at least one of:
when the maximum allowed rank is 1, the bitwidth of the indicator is ┌log₂(K₀)┐; or
when the maximum allowed rank is not 1, the bitwidth of the indicator is ┌log₂(2K₀)┐.

11. The method of claim 8, wherein K₀ is determined according to:
$${K}_{0} = {max}_{j ∈ \{ 1 , … , {N}_{L} \}} ⌈ 2 {L}_{j}^{Total} {M}_{x} β ⌉ ,$$
and wherein
$${M}_{x} = ⌈ {P}_{m} \times \frac{{N}_{3}}{R} ⌉ ,$$
where Pₘ denotes a FD-basis factor under a given rank of m; and
Lⱼ^{Total} denotes a total number of spatial-domain (SD) basis across the N_{RS} RS resources for j-th combination of parameters;
or
$${K}_{0} = {max}_{j ∈ \{ 1 , … , {N}_{L} \}} ⌈ ( {\sum }_{i = 1 , … , {N}_{R S}} 2 {L}_{i , j} {M}_{i , j , x} {β}_{i , j} ) ⌉ ,$$
and wherein
$${M}_{i , j , x} = ⌈ {P}_{i , j , m} \times \frac{{N}_{3}}{R} ⌉ ,$$
where P_{i,j,m} denotes a FD basis factor of the i-th RS and the j-th combination under a given rank of m.

12. The method of claim 1, wherein at least one of:
a same value of Pᵥ and a same value of beta (β), are each associated with each of the RSes;
a maximum number of non-zero coefficients summed for one layer is determined according to:
$$⌈ ( {\sum }_{i ∈ Set of used RS ( s )} 2 {L}_{i , J} ) {M}_{x} β ⌉ ;$$
or
a maximum number of non-zero coefficients summed across all layers is determined according to:
$$2 \times ⌈ ( {\sum }_{i ∈ Set of used RS ( s )} 2 {L}_{i , J} ) {M}_{x} β ⌉ ,$$
where ‘Set of used RS(s)’ is determined according the N_{UsedRS} RS resources, and J corresponds to the combination of parameters used for CSI determination;
$${M}_{x} = ⌈ {P}_{m} \times \frac{{N}_{3}}{R} ⌉ ,$$
where Pₘ denotes a frequency-domain (FD) basis factor for a FD basis factor under a given rank of m.

13. The method of claim 1, wherein a first group of the second part includes:
at least one indicators of selected spatial-domain (SD) bases,
wherein at least one of:
there are a number (N_{UsedRS}) of indicators of selected SD bases for each of the N_{UsedRS} RS resources; or
a first indicator, from the at least one indicators of selected SD bases, comprises at least one of an indicator of rotation factor for SD basis and an indicator of SD basis combination;
or
an indicator of a spatial-domain (SD) basis corresponding to a strongest co-efficient.

14. The method of claim 13, wherein the indicator of the spatial-domain (SD) basis corresponding to the strongest co-efficient is indicated across the N_{UsedRS} RS resources, and wherein the bitwidth of the indicator is
$$⌈ {log}_{2} ( {\sum }_{i ∈ Set of Used RS ( s )} 2 {L}_{i} ) ⌉$$
or
wherein at least one of:
for rank-1, the bitwidth of the indicator is ┌log₂(K^{NZ})┐, or
for other than rank-1,
$$⌈ {log}_{2} ( {\sum }_{i ∈ Set of Used RS ( s )} 2 {L}_{i} ) ⌉ .$$

15. The method of claim 1, wherein a second group of the second part includes:
an indicator of one or more selected frequency-domain (FD) bases,
wherein at least one of:
the indicator comprises a respective indicator provided for each of the N_{UsedRS} RS resources;
for rank-v transmission, if N₃<=a threshold, the bitwidth is
$$⌈ {log}_{2} ( \begin{matrix}{N}_{3} - 1 \\ {M}_{v} - 1\end{matrix} ) ⌉ - bit ;$$
for other than rank-v transmission, if N₃>the threshold, the bitwidth is
$$⌈ {log}_{2} ( \begin{matrix}2 {M}_{3} - 1 \\ {M}_{v} - 1\end{matrix} ) ⌉ - bit ;$$
or
an indicator of window of selected frequency-domain (FD) bases,
wherein:
the indicator is applied to all layers;
or
includes at least one indicator of offset of selected frequency-domain (FD) bases,
wherein at least one of:
the at least one indicator provides an offset of reference FD bases between one of the N_{UsedRS} RS resources and a reference RS resource;
the at least one indicator is provided for one of the N_{UsedRS} RS resources except for the reference RS resource, wherein a number of the at least one indicator is (N_{UsedRS}−1);
bitwidth of the at least one indicator is ┌log₂(┌N₃×b┐)┐-bit, where b is provided in the configuration; or
a candidate value of the at least one indicator of offset between reference FD bases is from a range of 0 to N₃−1/b;
or
reference amplitudes for at least one specific layer;
or
at least one first group of amplitude values for at least one non-zero coefficient, and
wherein a first group of amplitude values for a non-zero coefficient is determined according to a priority function;
or
at least one first group of phase values for at least one non-zero coefficient, and
wherein a first group of phase values for a non-zero coefficient is determined according to a priority function;
or
at least one first group of indicators for at least one non-zero coefficient, and
wherein a first group of indicators for a non-zero coefficient is determined according to a priority function.

16. The method of claim 1, wherein when the CSI report cannot be fully carried in physical uplink shared channel (PUSCH), the wireless communication device omits a portion of the second part; or
wherein a group of the second part has a lower priority for omission relative to another group that is earlier in order or has a lower group index in the second part; or
wherein the wireless communication device prioritizes bits for amplitude values for non-zero coefficients, for phase values for the non-zero coefficients, or for indicators for non-zero coefficients, according to a priority function, to be carried in the PUSCH.

17. The method of claim 16, wherein when a number of layers is v, a number of SD basis is L, and a number of FD basis is Mv, the priority function has a value determined according to 2*L*v*Mv*t.

18. A wireless communication device, comprising:
at least one processor configured to:
receive, via a receiver from a wireless communication node, a configuration associated with a set of N_{RS} reference signal (RS) resources, where N_{RS} is a positive integer value;
receive, via the receiver from the wireless communication node, the at least one RS corresponding to the N_{RS} RS resources; and
generate, according to N_{UsedRS} RS resources of the N_{RS} RS resources, a channel state information (CSI) report, the CSI report comprising a first part and a second part, where N_{UsedRS} is a positive integer value.

19. A method comprising:
transmitting, by a wireless communication node to a wireless communication device, a configuration associated with a set of N_{RS} reference signal (RS) resources, where N_{RS} is a positive integer value; and
transmitting, by the wireless communication node to the wireless communication device, the at least one RS corresponding to the N_{RS} RS resources,
wherein a channel state information (CSI) report is generated according to N_{UsedRS} RS resources of the N_{RS} RS resources, the CSI report comprising a first part and a second part, where N_{UsedRS} is a positive integer value.

20. A wireless communication node, comprising:
at least one processor configured to:
transmit, via a transmitter to a wireless communication device, a configuration associated with a set of N_{RS} reference signal (RS) resources, where N_{RS} is a positive integer value; and
transmit, via the transmitter to the wireless communication device, the at least one RS corresponding to the N_{RS} RS resources,
wherein a channel state information (CSI) report is generated according to N_{UsedRS} RS resources of the N_{RS} RS resources, the CSI report comprising a first part and a second part, where N_{UsedRS} is a positive integer value.
